(19) United States
(12) Patent Application Publication
(10) Pub. No.: US 2026/0280649 A1
(43) Pub. Date: Sep. 17, 2026

(54) REDUCING ERRORS IN USING COMPRESSED CHANNEL STATE INFORMATION REPORTS OR INDICATIONS

(71) Applicant: Google LLC, Mountain View, CA (US)

(72) Inventor: Yushu ZHANG, Beijing (CN)

(21) Appl. No.: 19/472,595

(22) PCT Filed: Apr. 7, 2023
(86) PCT No.: PCT/CN2023/086910

§ 371 Date: Oct. 3, 2025

(51) Int. Cl. H04B 7/06; H04L 41/16

(52) U.S. Cl. CPC H04B 7/0626; H04B 7/0632; H04B 7/0639; H04L 41/16

(57) ABSTRACT

Methods, systems, and techniques are disclosed for reducing errors in using compressed channel quality reports or indications. An example method includes receiving (304) by a user equipment (UE) from a network entity a channel state information (CSI) report configuration that includes information associated with a mismatch between compression and decompression of CSI. The UE receives (310), from the network entity, multiple reference signals for generating a CSI report based on the CSI report configuration. The UE transmits (312), to the network entity, the CSI report including the information associated with the mismatch between the compression and decompression of the precoder matrix in the CSI. As such, the network entity uses the information to decompress the CSI report with improved accuracy or fidelity.

WO

### FIELD

This disclosure relates generally to wireless communication, and more particularly, to reporting channel state information.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

In 5G NR, a base station (or a network entity in general) receives channel state information (CSI) reports from a UE to optimize various aspects of communication, such as beamforming, scheduling, and link adaptation. The CSI reports contain useful information about the channel conditions experienced by the UE. An example CSI report may include components such as: reference signal received power (RSRP), received signal strength indicator (RSSI), signal to interference plus noise ratio (SINR), precoding matrix indicator (PMI), rank indicator (RI), and channel quality indicator (CQI). The UE often compresses the CSI report before transmission to reduce the transmission overhead. When the base station receives the compressed CSI report, the base station performs decompression to obtain the information in the CSI report.

The compression techniques may involve quantization, codebook based encoding, as well as other compression schemes (also referred to as algorithms, models, and the like). The decompression operation may include decoding, quantization reversal, codebook-based decompression, reconstruction, among others. Depending on various constraints (e.g., volume budget, latency, etc.), the UE and the base station may use different algorithms or models for compression and for decompression. Even if a same algorithm is used by both the UE and the base station, the respective compression and decompression models may use different parameters trained using machine learning algorithms to achieve respective objectives (e.g., accuracy vs. speed).

As a result, the decompressed CSI report may be different from the original CSI report. Such errors or mismatch inadvertently cause misinterpretation on the base station side (such as quantization error, insufficient codebook resolution, outdated CSI information, etc.) and lead to mistaken channel estimation, negatively affecting beamforming, scheduling, link adaptation, and other channel quality related operations or configurations.

### SUMMARY

The present disclosure provides methods, systems, and techniques for reducing errors in using compressed channel quality reports or indications. For example, when a user equipment (UE) provides channel state information (CSI) report to a network entity, content of the CSI report is often compressed for reducing transmission overhead. The network entity may use a separate algorithm or model to decompress the content of the CSI report and result in unintentional mismatching content, causing misunderstanding between the UE and the network entity. The present disclosure provides techniques for reducing errors related to compression and decompression associated with the CSI report.

A CSI report often includes at least one of rank indicator (RI), precoder matrix indicator (PMI), channel quality indicator (CQI), and layer indicator (LI). The network entity uses RI and PMI to identify proper transmission parameters. For example, RI provides information about the optimal number of spatial layers for multi-input-multi-output (MIMO) transmission. PMI indicates to the network entity the preferred precoding matrix to be used with the UE. The network entity selects a precoding matrix for downlink transmissions based on the received PMI. CQI indicates to the network entity the signal-to-interference plus noise (SINR) status so as to assist the network entity to determine the modulation and coding scheme (MCS). LI identifies the strongest layer for the reported precoder indicated by RI and PMI.

Reporting CQI, PMI, and RI may cost a large overhead. To reduce the overhead, one or more of the CQI, PMI, and RI may be compressed on the UE side before transmission, and decompressed on the network entity side after reception. The UE and the network entity may use any technique for such compression/decompression procedures, such as delta compression (e.g., providing new information based on previous CSI reports) and transform-based compression (e.g., mathematical transformation that reduces signal volume size). For example, transform-based compression algorithms may include Discrete Fourier Transform (DFT), Discrete Cosine Transform (DCT), Discrete Wavelet Transform (DWT), machine learning (ML) based algorithms, and other mathematical algorithms or models.

When the UE and the network entity use respectively trained ML based algorithms for compressing and decompressing the signals, mismatch may occur. For example, the UE may use a first transform-based model with parameters trained using ML techniques to compress the PMI. The network entity receives the compressed PMI and decompresses the PMI using a second transform-based model with separately trained parameters (e.g., the ML model, training dataset, or training steps may result in the second model being different from the first model, even if a common base model is used while the parameters as a result of ML based training are different). As a result, the precoders indicated by the decompressed PMI differs from the precoders indicated by the original PMI the UE intended to report, causing mismatch of information between the UE and the network entity. The different precoders might cause different channel quality assumptions, which correspond to different CQIs. Due to the mismatch, the network entity may not be able to determine optimal downlink transmission parameters.

The present disclosure provides techniques for reducing such mismatch of information, such as by providing mismatch compensation for the CQI report or using information that reduces such mismatch during CQI reporting. Benefits of this disclosure includes reducing misunderstanding between the UE and the network entity regarding channel quality reporting, and improving the accuracy for selecting an appropriate MCS, which results in improved system performance and reliability than if an MCS is selected based on mis-decompressed CQI, RI, or other content in the CSI reporting.

An example method includes receiving by a UE from a network entity a CSI report configuration that includes information associated with a mismatch between compression and decompression of CSI. The UE receives, from the network entity, multiple reference signals for generating a CSI report based on the CSI report configuration. The UE transmits, to the network entity, the CSI report including the information associated with the mismatch between the compression and decompression of the precoder matrix in the CSI. As such, the network entity uses the information to decompress the CSI report with improved accuracy or fidelity.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 illustrates an example of channel quality indicator (CQI) mismatch between a UE and a network entity due to channel state information (CSI) compression, such as machine learning (ML) based compression, according to aspects of the present disclosure.

FIG. 3 is a signaling diagram illustrating communications between a UE and a network entity for reducing errors in using compressed channel quality reports or indications, according to aspects of the present disclosure.

FIG. 4 is a flowchart of a method of reducing errors in using compressed channel quality reports or indications at a UE, according to aspects of the present disclosure.

FIG. 5 is a flowchart of a method of reducing errors in using compressed channel quality reports or indications at a network entity, according to aspects of the present disclosure.

FIG. 6 is a signaling diagram illustrating communications between a UE and a network entity for reducing errors using a compensation factor, according to aspects of the present disclosure.

FIG. 7 illustrates an example of providing an absolute CQI compensation factor for calculating the CQI report, according to aspects of the present disclosure.

FIG. 8 illustrates an example of providing an accumulative CQI compensation factor for calculating the CQI report, according to aspects of the present disclosure.

FIG. 9 illustrates an example of providing a UE determined CQI compensation factor for calculating the CQI report, according to aspects of the present disclosure.

FIG. 10 is a signaling diagram illustrating communications between a UE and a network entity for reducing errors using demodulation reference signal (DMRS) based CQI or rank indicator (RI) report, according to aspects of the present disclosure.

FIG. 11 illustrates an example of a CQI/RI report and physical downlink shared channel (PDSCH) triggered by one downlink control information (DCI) and the CQI/RI and hybrid automatic request acknowledgment (HARQ-ACK) information reported by one physical uplink control channel (PUCCH) resource, according to aspects of the present disclosure.

FIG. 12 illustrates an example of a CQI/RI report and PDSCH triggered by one DCI and the CQI/RI and HARQ-ACK information reported by separate PUCCH resources, according to aspects of the present disclosure.

FIG. 13 illustrates an example of a CQI/RI report and PDSCH triggered by separate DCIs, according to aspects of the present disclosure.

FIG. 14 illustrates an example of a CQI/RI report based on selected DMRS ports, according to aspects of the present disclosure.

FIG. 15 illustrates an example of a CQI offset report based on DMRS for PDSCH, according to aspects of the present disclosure.

FIG. 16 is a signaling diagram illustrating communications between a UE and a network entity for reducing errors using one or more CSI reference signal (CSI-RS) resources for port-selection based CQI report, according to aspects of the present disclosure.

FIG. 17 illustrates an example of a CSI-RS resource indicator (CRI) and CQI report based on a set of CSI-RS resources, according to aspects of the present disclosure.

FIG. 18 illustrates an example of a port selection indicator (PSI) and CQI report based on a CSI-RS resource, according to aspects of the present disclosure.

FIG. 19 is a flowchart of a method of wireless communication at a UE, according to aspects of the present disclosure.

FIG. 20 is a flowchart of a method of wireless communication at a network entity, according to aspects of the present disclosure.

FIG. 21 is a diagram illustrating a hardware implementation for an example UE apparatus.

FIG. 22 is a diagram illustrating a hardware implementation for one or more example network entities.

Like reference numerals indicate like elements.

### DETAILED DESCRIPTION

The present disclosure provides methods, systems, and techniques for reducing errors in using compressed channel quality reports or indications. In an aspect, a user equipment (UE) transmits additional information to the network entity for reducing potential errors during decompressing, by the network entity, content in a channel state information (CSI) report, such as the channel quality indicator (CQI), rank indictor (RI), and other information in the CSI report. The potential errors may be due to mismatch as a result of using different algorithms, models, or machine-learning training processes between the UE and the network entity. The present disclosure provides example communication mechanisms or additional information to reduce such errors.

In conventional practices, a network entity may configure a CSI report configuration for a UE to report the CSI. In a CSI report, the UE may include a rank indicator (RI), a precoder matrix indicator (PMI), a channel quality indicator (CQI), a layer indicator (LI), and other information. The UE uses the RI and the PMI to indicate the digital precoder. The UE uses the CQI to indicate the signal-to-interference plus noise (SINR) status so as to assist the network entity to determine the modulation and coding scheme (MCS). The UE uses the LI to identify the strongest layer for the reported precoder indicated by the RI and the PMI.

For the CSI report, the network entity may configure, in the UE, measurement and report granularity for the CQI and PMI. The network entity may configure the UE to report wideband or subband CQI and the wideband or subband PMI. The network entity may configure the codebook for the RI and PMI report as Type1 codebook, Type2 codebook, eType2 codebook, among others. Based on the precoder indicated by the reported RI and PMI, the UE reports the CQI in the CSI report, as well as the channel condition measured based on channel state information reference signals (CSI-RS).

The content of the CSI report may occupy a large overhead if not compressed. For example, depending on quantization levels, the CQI may occupy 4-15 bits. The PMI overhead depends on the codebook size and is often higher than the CQI overhead (e.g., requiring more bits to represent a precoding matrix). Though the exact number of bits for the CSI report overhead depends on many variables (e.g., codebook, system configuration, etc.), the CSI report is often compressed to reduce the actual data volume for transmission.

Various compression/decompression techniques may be used, such as transform-based compression that uses a set of coefficients or parameters to mathematically transform the information for size reduction. For example, to reduce the large overhead for subband PMIs report, machine learning compression algorithms have been introduced to compress the subband PMIs. The UE may compress all or part of the subband PMIs by machine learning and report the compressed subband PMIs to the network entity, and the network entity may decompress the received compressed subband PMIs.

Using machine learning models (as well as other compression models), however, may introduce mismatching between the decompressed CSI report (e.g., the precoding matrix therein) and the original. For example, when machine learning (ML) models are used for compression, different parameters may result based on different training datasets and different objectives (e.g., accuracy vs. overhead size). As a result, the UE would not have information on the exact neural network (or ML algorithm/model) used for decompressing the precoding matrix on the network entity side. Similarly, the network entity has no information on the exact neural network or ML model used for compressing the precoding matrix on the UE side. Such a lack of understanding (as well as other causes) might lead to mismatch or errors in obtaining the precoding matrix that the UE intends to report. The present disclosure provides techniques to reduce such errors in using compressed channel quality reports or indications.

In some aspects, this disclosure provides methods for channel quality report to avoid channel quality mismatch between the network entity and UE. For example, the disclosure provides techniques of CQI report with CQI mismatch compensation. The disclosure also provides techniques of CQI report based on DMRS of PDSCH, as well as CQI report based on port-selection CSI-RS. These techniques may reduce channel quality mismatch between the network entity and UE, thus improving accuracy for MCS selection, resulting in improved system performance and reliability.

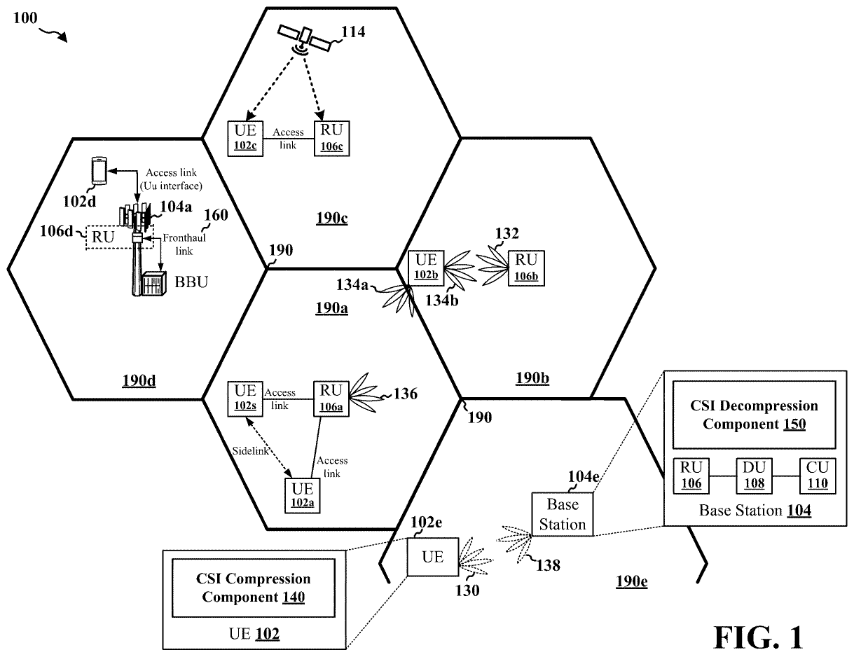

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 may be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which may enable flexibility in network designs. The various units of the disaggregated base station architecture, or the disaggregated RAN architecture, may be configured for wired or wireless communication with at least one other unit. For example, the base stations 104a/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units may be configured to communicate with one or more other base stations 104 or one or more other disaggregated base station units via the wired or wireless transmission medium. In examples, a processor, a memory, and/or a controller associated with executable instructions for the interfaces may be configured to provide communication between the base stations 104 and/or the one or more disaggregated base station units via the wired or wireless transmission medium. For example, a wired interface may be configured to transmit or receive the information/signals over a wired transmission medium, such as via the fronthaul link 160 between the RU 106d and the baseband unit (BBU) of the base station 104d associated with the cell 190d. The BBU includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 may be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.” Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas 114 of the base station 104d of cell 190d to transmit a downlink/forward link communication to the UE 102d or receive an uplink/reverse link communication from the UE 102d based on the Uu interface associated with the access link between the UE 102 d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 may be implemented as an IAB node, a relay node, a sidelink node, an aggregated (monolithic) base station with an RU 106 and a BBU that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e may be a master node and the base station/RU 160a may be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a CSI compression component 140 configured to receiving, from a network entity, a CSI report configuration that includes information associated with a mismatch between compression and decompression of CSI. The CSI compression component 140 receives, from the network entity, multiple reference signals for generating a CSI report based on the CSI report configuration. The CSI compression component 140 transmits, to the network entity, the CSI report including the information associated with the mismatch between the compression and decompression of the CSI.

In certain aspects, any of the base stations 104 or a network entity of the base stations 104 may include a CSI decompression component 150 configured to transmitting, to the UE, a CSI report configuration that includes information associated with a mismatch between compression and decompression of CSI. The CSI decompression component 150 transmits, to the UE, a plurality of reference signals for generating a CSI report based on the CSI report configuration. The CSI decompression component 150 receives, by the network entity, the CSI report including the information associated with the mismatch between the compression and decompression of the precoder matrix in the CSI.

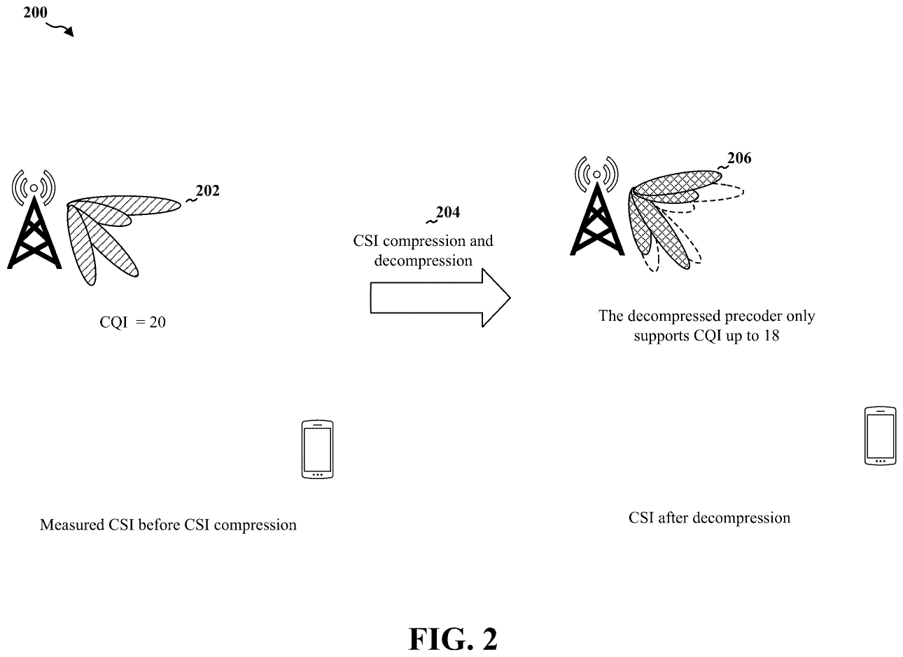

Accordingly, FIG. 1 describes a wireless communication system that may be implemented in connection with aspects of one or more other figures described herein, such as aspects illustrated in FIGS. 2-15. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2 illustrates an example 200 of CQI mismatch between a UE and a network entity due to CSI compression, such as ML based compression, according to aspects of the present disclosure. As shown, the UE measures CSI of the downlink beams 202 before CSI compression (e.g., CQI=20). When the UE reports the measured the CSI, the UE compresses 204 the precoder (e.g., PMI) of the CSI and transmits the compressed CSI to the network entity. The network entity then decompresses the received CSI.

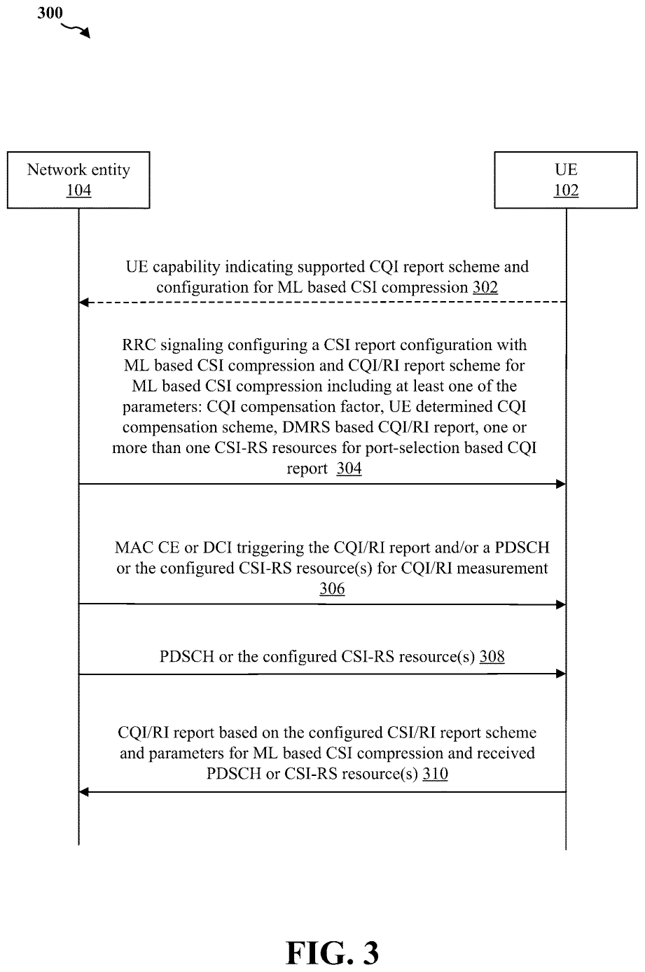

Due to different ML based models or parameters on the UE side and on the network entity side, the decompressed precoder may support CQI only up to 18 (while the original CQI=20). This results in mismatched beams 206 (compared to the original beams 202 shown in dashed lines in FIG. 2). For example, the UE measures CQI based on the channel and precoders. Different precoders lead to different CQIs. Compression errors for the reported precoders took place for various reasons, including differences in the algorithm, model, or training for the ML based compression/decompression operations. Therefore, such compression error in FIG. 2 causes CQI mismatch. The reported CQI is for an ideal (e.g., the best among that is available) precoder but the actual transmission is based on a misinterpreted precoder due to decompression error(s). As further discussed below in FIGS. 3-5, this disclosure provides methods for reducing such errors.

FIG. 3 is a signaling diagram 300 illustrating communications between the UE 102 and the network entity 104 for reducing errors in using compressed channel quality reports or indications, according to aspects of the present disclosure. The signaling diagram 300 illustrates one example procedure for CQI/RI report for ML based CSI compression. As shown, the UE 102 reports 302 the capability on the supported CQI/RI report scheme and configuration for ML based CSI compression to the network entity 104.

For example, the capabilities regarding the supported CQI/RI report include at least one of: (1) whether the UE 102 supports joint or separate CQI/RI report with the ML compressed CSI; (2) whether the UE 102 supports CQI/RI report based on DMRS for PDSCH or CSI-RS for port selection; and (3) the maximum number of CQI compensation factors that the UE 102 may maintain per component carrier (CC) or across CCs in a band or band combination. The capability report or indication enables the network entity 104 to identify what information may reduce errors related compression/decompression of the CSI report.

Based on the reported UE capability, the network entity 104 configures 304 the CQI/RI report scheme and parameters for ML based CSI compression by Radio Resource Control (RRC) signaling, e.g., RRCReconfiguration. The network entity 104 may configure one or more than one of the parameters, including: CQI compensation factor, UE determined CQI compensation scheme, DMRS based CQI/RI report, and one or more than one CSI-RS resources for port-selection based CQI report.

The network entity then transmits 306 a Medium Access Control (MAC) Control Element (CE) or Downlink Control Information (DCI) triggering the CQI/RI report for ML based CSI compression and/or PDSCH or the configured CSI-RS resource(s) for CQI/RI. The network entity transmits 308 the PDSCH or the configured CSI-RS resource(s) for CQI/RI measurement. In response, the UE 102 reports 310 the CQI/RI based on the received PDSCH or CSI-RS resource(s) and the configuration for CQI/RI report scheme for ML based CSI compression.

In this disclosure, unless specified, a RRC signaling may indicate a RRC reconfiguration message from the network entity to UE, or a system information block (SIB), where the SIB may be an existing SIB (e.g., SIB1) or a new SIB (e.g., SIB J, where J is an integer above 21) transmitted by the network entity. In some implementations, the network entity receives the one or more capabilities from a core network (e.g., Access and Mobility Management Function (AMF)). In yet some other implementations, the network entity receives the one or more capabilities from another base station (e.g., gNB or eNB).

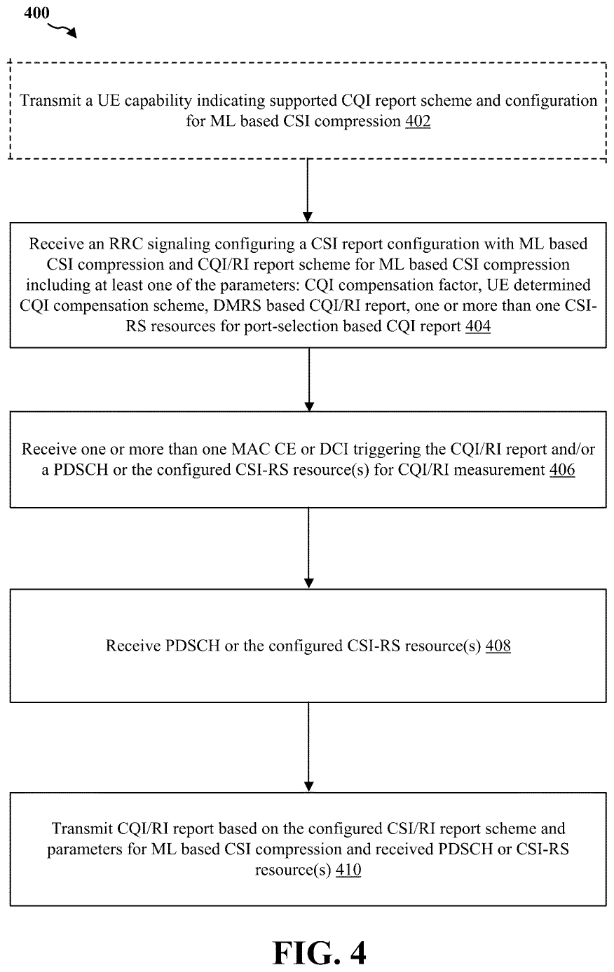

FIG. 4 is a flowchart 400 of a method of reducing errors in using compressed channel quality reports or indications at a UE, according to aspects of the present disclosure. As shown, the UE optionally transmits 402 a UE capability indicating supported CQI report scheme and configuration for ML based CSI compression to a network entity. The UE receives 404, from the network entity, an RRC signaling configuring a CSI report configuration. The signaling includes CSI report configuration for ML based CSI compression and a CQI/RI report scheme for ML based CSI compression. The configuration includes at least one of the following parameters: a CQI compensation factor, a UE determined CQI compensation scheme, a DMRS based CQI/RI report, and one or more CSI-RS resources for port-selection based CQI report.

The UE receives 406, one or more MAC CE or DCI triggering the CQI/RI report and/or a PDSCH or the configured CSI-RS resources for CQI and RI measurements. The UE receives 408 PDSCH or the configured CSI-RS resources from the network entity. The UE then transmits the CQI/RI report based on the configured CSI/RI report scheme and parameters for ML based CSI compression and received PDSCH or CSI-RS resource(s).

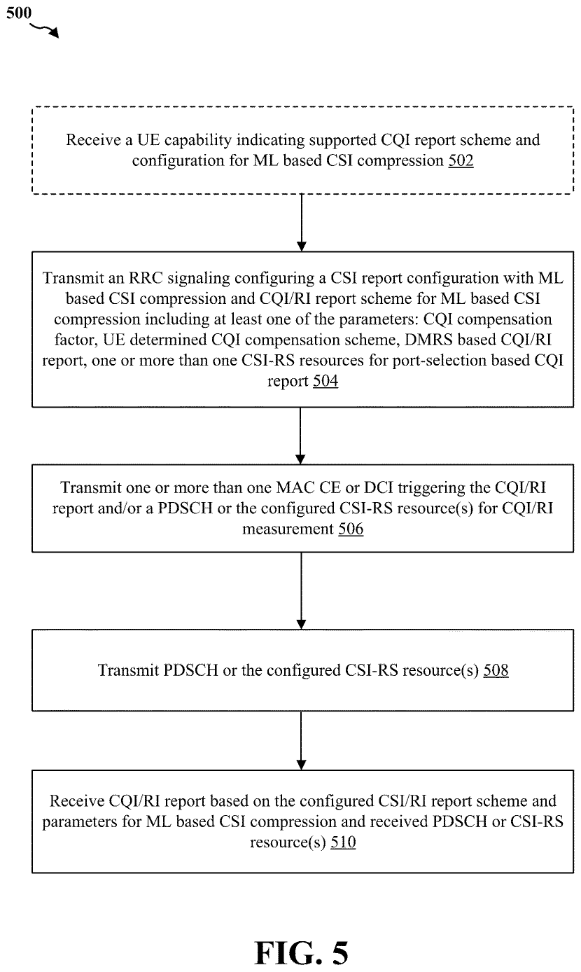

FIG. 5 is a flowchart 500 of a method of reducing errors in using compressed channel quality reports or indications at a network entity, according to aspects of the present disclosure. The flowchart 500 may be complementary to the UE's behavior in the flowchart 400. As shown, the network entity receives 502 a UE capability indicating the supported CQI report scheme and configuration for ML based CSI compression. The network entity transmits 504, an RRC signaling configuring a CSI report configuration with ML based CSI compression and CQI/RI report scheme for ML based CSI compression. The configuration similarly includes at least one of the following parameters: a CQI compensation factor, a UE determined CQI compensation scheme, a DMRS based CQI/RI report, and one or more CSI-RS resources for port-selection based CQI report.

The network entity transmits 506 one or more MAC CE or DCI triggering the CQI/RI report and/or a PDSCH or the configured CSI-RS resource(s) for CQI/RI measurements. The network entity then transmits 508 PDSCH or the configured CSI-RS resources to the UE. The network entity receives 510, CQI/RI report based on the configured CSI/RS report scheme and parameters for ML based CSI compression and received PDSCH or CSI-RS resources.

Although FIGS. 3-5 use ML based CSI compression as examples, various transform-based compression/decompression algorithms or models may be used for reducing the transmission overhead of the CSI report.

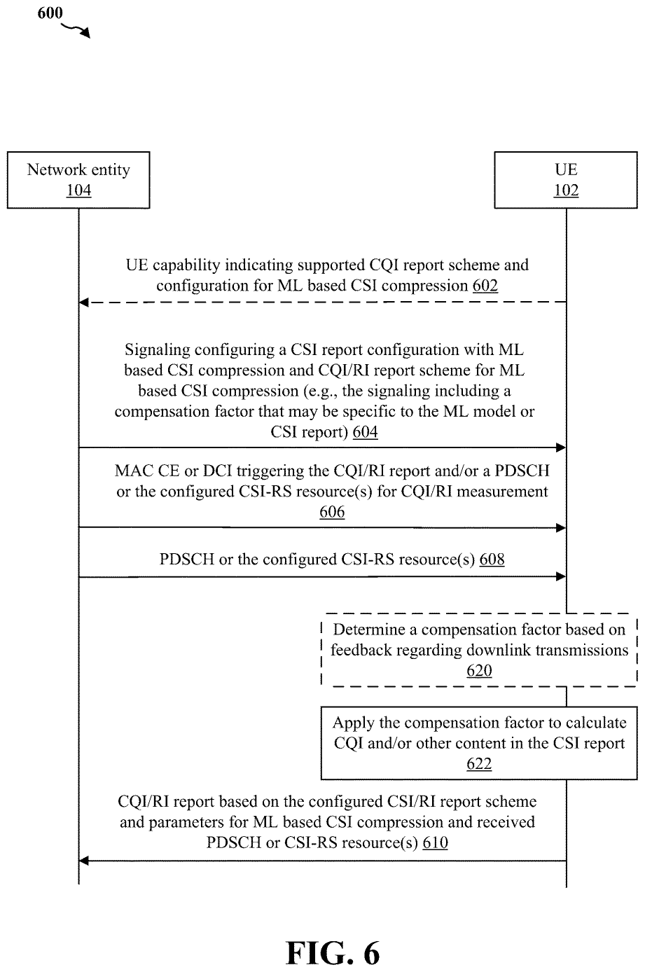

FIG. 6 is a signaling diagram 600 illustrating communications between the UE 102 and the network entity 104 for reducing errors using a compensation factor, according to aspects of the present disclosure. As shown, similar to the operations in FIG. 3, the UE 102 optionally transmits 602 the UE capability indicating supported CQI report scheme and the configuration for ML based CSI compression to the network entity 104. The network entity 104 transmits 604 to the UE 102 signaling that configures a CSI report configuration with ML based CSI compression and CQI/RI report scheme for ML based CSI compression. The signaling includes a compensation factor that may be specific to the ML model or the CSI report.

The network entity 104 then transmits 606 a MAC CE or DCI triggering the CQI/RI report and/or a PDSCH or the configured CSI-RS resource(s) for CQI/RI measurement. The network entity 104 transmits 608 PDSCH or the configured CSI-RS resources to the UE 102. In some cases, the UE 102 may determine 620 a compensation factor based on feedback regarding the downlink transmissions (e.g., the PDSCH at 608). The UE 102 applies 622 the compensation factor to calculate CQI and/or other content in the CSI report. The UE 102 transmits 610 CQI/RI report based on the configured CSI/RS report scheme and parameters for the ML based CSI compression and the received PDSCH or CSI-RS resources.

When the network entity 104 configures a CQI compensation factor for CQI calculation (e.g., operation 604), the network entity 104 may determine the CQI compensation factor based on the hybrid repeat automatic request (HARQ) acknowledgement (ACK) information reported by the UE 102. For example, the network entity 104 may determine a negative CQI compensation factor for a ML model if the network entity 104 receives one or more than one consecutive negative-ACK (NACK) for the PDSCH with the CSI based on the ML model. Likewise, the network entity 104 may determine a positive CQI compensation factor if the network entity 104 receives one or more than one consecutive ACK(s). The UE 102 may apply the CQI compensation factor for CSI report corresponding to the ML model.

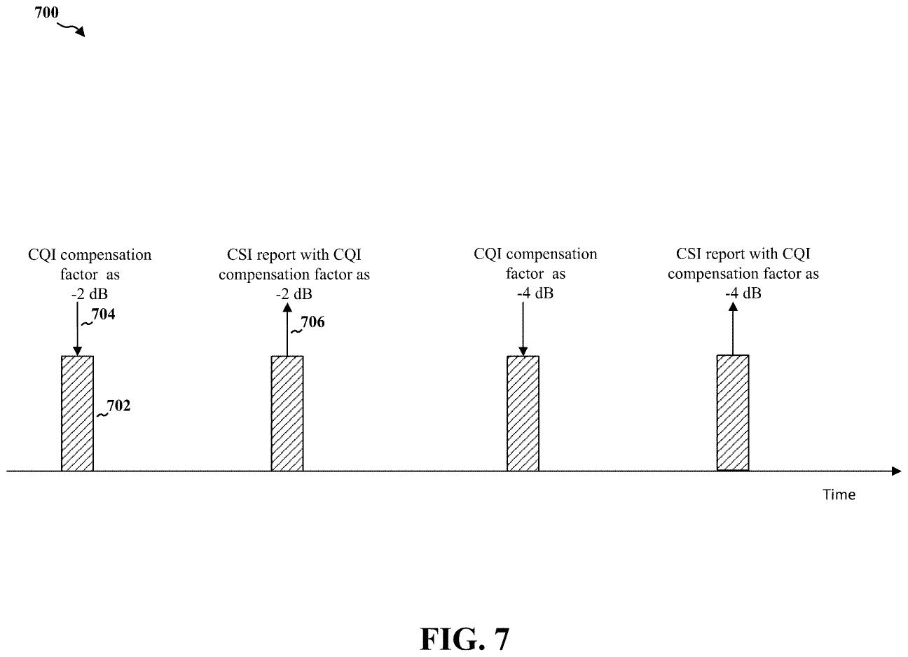

FIG. 7 illustrates an example 700 of providing an absolute CQI compensation factor for calculating the CQI report, according to aspects of the present disclosure. An absolute CQI compensation factor is standalone and does not consider prior compensation factors. As shown, the network entity may transmit 704 (e.g., downlink) signaling 702 to the UE and indicates a CQI compensation factor of −2 dB (or −4 dB in the subsequent instance). The UE may report 706 (e.g., uplink) the CSI report upon applying the CQI compensation factor as −2 dB (or −4 dB in the subsequent instance). When the absolute CQI compensation factor is configured or used, the UE applies the latest configured CQI compensation factor. In the example 700, if the second CQI compensation factor of −4 dB is the latest, the UE applies the −4 dB in the CSI report.

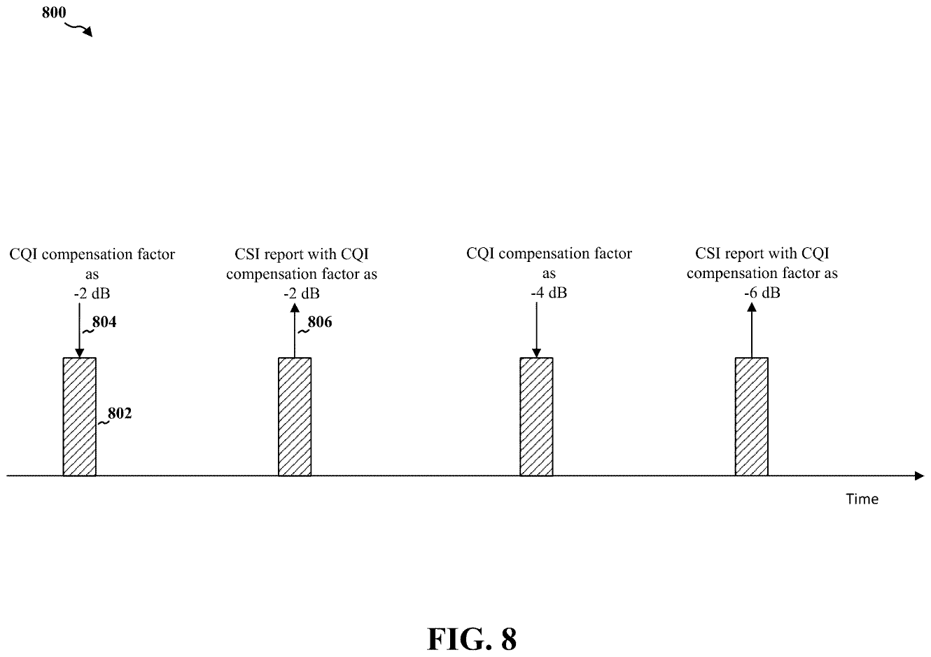

FIG. 8 illustrates an example 800 of providing an accumulative CQI compensation factor for calculating the CQI report, according to aspects of the present disclosure. An accumulative CQI compensation factor may combine with an existing CQI compensation factor. As shown, the network entity may transmit 804 signaling 802 to the UE and indicates a first CQI compensation factor of −2 dB. The UE may correspondingly report 806 the CSI report upon applying the CQI compensation factor as −2 dB. The network entity may further indicate a second CQI compensation factor of −4 dB. In the accumulative update manner, the UE combines the two compensation factors (−2 dB and −4 dB) and applies −6 dB to compute contents for the CSI report. As such, the UE applies the latest configured CQI compensation factor on top of current CQI compensation factor.

When accumulative compensation factors are configured, the UE may reset the CQI compensation factor in view of one or a subset of the following events. The UE may reset the compensation factor when the UE completes a handover procedure. The UE may reset the compensation factor when the UE activates or deactivates the serving cell. The UE may reset the compensation factor when the UE switches to a new bandwidth part. The UE may reset the compensation factor when the UE switches to a new ML model. The UE may reset the compensation factor when the UE receives a signaling updating the configuration for the CSI-RS configured as channel measurement resource (CMR). The UE may reset the compensation factor when the UE receives a signaling updating the CSI report configuration.

In some other implementations, the network entity may configure the CQI compensation factor indication mode, e.g., whether it is based on absolute update manner (as shown in FIG. 7) or accumulative update manner (as shown in FIG. 8). The network entity may configure the CQI compensation factor indication mode by RRC signaling, MAC CE, or DCI. In one example, the network entity may configure the CQI compensation factor indication mode in the control signaling used to indicate the value of the CQI compensation factor. The UE may report the supported CQI compensation factor indication mode(s), e.g., whether it supports absolute update, accumulative update, or both.

In some implementations, the network entity configures the CQI compensation factor by RRC signaling. The network entity may configure the CQI compensation factor specific to each ML model or specific to each CSI report configuration.

In some other implementations, the network entity configures the CQI compensation factor by MAC CE. The MAC CE may include at least one of the following elements: (1) serving cell index used to indicate the serving cell index to apply the CQI compensation factor; (2) bandwidth part index used to indicate the bandwidth part index to apply the CQI compensation factor; (3) CSI report configuration identifier (ID) used to indicate the CSI report configuration identifier to apply the CQI compensation factor; (4) ML model ID used to indicate the ML model for CSI compression to apply the CQI compensation factor; and (5) CQI compensation factor used to indicate a factor for CQI compensation or the UE-assumed power offset between the CSI-RS and PDSCH for CQI calculation. After X (e.g., a predefined or configured value) millisecond (ms) or symbols or slots after the UE reports the last symbol ACK for the PDSCH with the MAC CE, or after X ms or symbols or slots after the UE receives the last symbol of the PDSCH with the MAC CE, the UE starts to apply the CQI compensation factor for CQI measurement and report corresponding to the CSI report configuration ID or the ML model with the indicated ML model ID. The value of X may be predefined or configured by RRC signaling or MAC CE, or reported by the UE via UE capability report.

In some implementations, the network entity configures the CQI compensation factor by DCI. In one example, the network entity configures the CQI compensation factor by the DCI used to trigger the CSI report. Thus, the network configures different CSI requests corresponding to different CQI compensation factor. By indicating different value of the DCI field CSI report, the network entity may trigger a CSI report corresponding to a CSI compensation factor. In another example, the network entity configures the CQI compensation factor by a dedicated DCI. The content of the CQI compensation factor may be similar to the MAC CE based CQI compensation factor configuration. The UE may transmit HARQ-ACK information for the DCI. After Y millisecond (ms) or symbols or slots after the UE reports the last symbol ACK for the DCI, or after Y ms or symbols or slots after the UE receives the last symbol of the DCI, the UE starts to apply the CQI compensation factor for CQI measurement and report corresponding to the CSI report configuration ID or the ML model with the indicated ML model ID. The value of Y may be predefined or configured by RRC signaling, MAC CE, or DCI or reported by the UE via UE capability report.

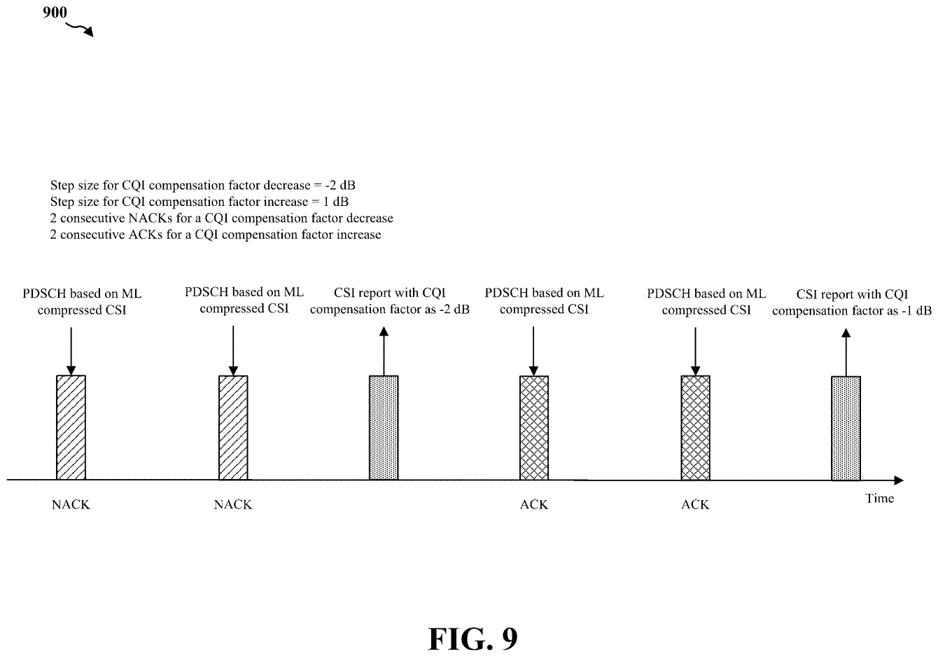

FIG. 9 illustrates an example 900 of providing a UE determined CQI compensation factor for calculating the CQI report, according to aspects of the present disclosure. In the example 900, the UE determines the CQI compensation factor based on the ACK/NACK status for the PDSCH. The network entity may configure the step size for increasing and/or decreasing the CQI compensation factor by RRC signaling, MAC CE or DCI. The network entity may configure a common step size or separate step sizes for increasing and decreasing the CQI compensation factor. The network entity may configure the condition to increase or decrease the CQI compensation factor, e.g., number of consecutive NACKs to decrease the CQI compensation factor and number of consecutive ACKs to increase the CQI compensation factor.

As shown in FIG. 9, as the network entity configures the step size for increasing the compensation factor to be 1 dB and for decreasing the compensation factor to be −2 dB, and the consecutive number for triggering the compensation factor to be two, when the UE provides two NACKs, the compensation factor of −2 dB is triggered. When the UE provides two ACKs, the compensation factor of 1 dB is triggered and combined with the previous compensation factor of −2 dB to reach −1 dB for applying to the CSI report.

In some implementations, the UE maintains a common CQI compensation factor specific to a ML model (or compression/decompression scheme, algorithm, etc.). For a PDSCH, the network entity may indicate whether the PDSCH is based on the received ML compressed CSI or not by the scheduling DCI. Then the UE determines whether to increase or decrease the CQI compensation factor based on the ACK/NACK status for the PDSCH if the PDSCH is based on the ML compressed CSI.

In some implementations, the UE maintains separate CQI compensation factors for each ML model. For a PDSCH, the network entity may indicate the corresponding ML model ID for the compressed CSI. A predefined or default value for the ML model ID may indicate the PDSCH is not based on ML based CSI. Then the UE determines whether to increase or decrease the CQI compensation factor for a ML model based on the ACK/NACK status for the PDSCH and the indicated ML model ID.

In some implementations, the network entity may configure the maximum and/or minimum CQI compensation factor. The UE may report an indicator to the network entity if the CQI compensation factor reaches the configured maximum or minimum CQI compensation factor. The UE may report the indicator by RRC signaling, e.g., UE assistance information, or MAC CE, or uplink control information (UCI) in PUCCH or PUSCH.

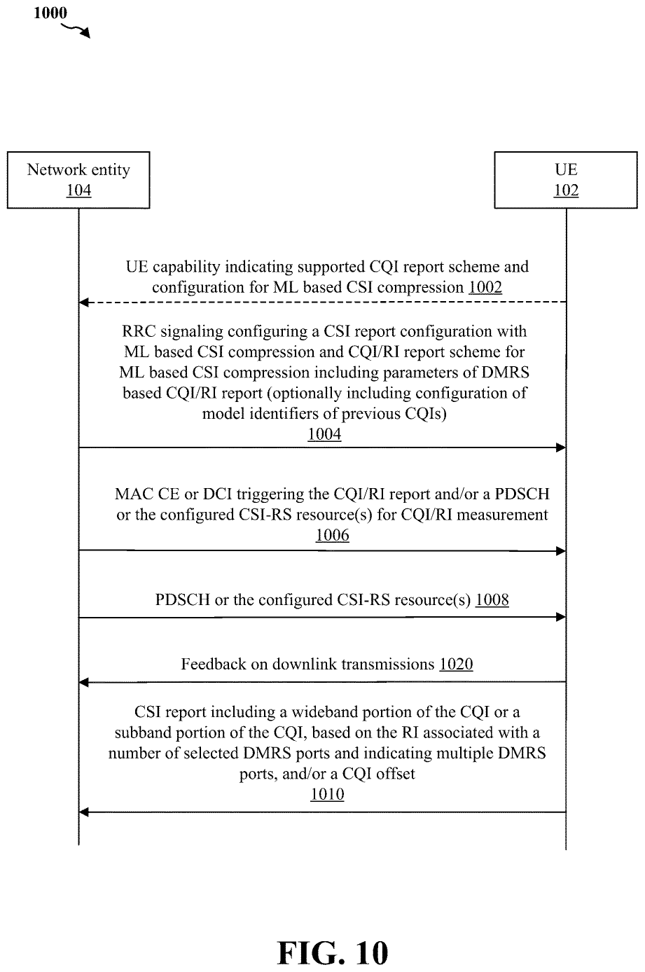

FIG. 10 is a signaling diagram 1000 illustrating communications between a UE and a network entity for reducing errors using demodulation reference signal (DMRS) based CQI or rank indicator (RI) report, according to aspects of the present disclosure. As shown, similar to the operations in FIG. 3, the UE 102 optionally transmits 1002 the UE capability indicating supported CQI report scheme and the configuration for ML based CSI compression to the network entity 104. The network entity 104 transmits 1004 to the UE 102 signaling that configures a CSI report configuration with ML based CSI compression and CQI/RI report scheme for ML based CSI compression. The signaling includes parameters of DMRS based CQI/RI report (and optionally includes configuration of model IDs of previous CQIs).

The network entity 104 then transmits 1006 a MAC CE or DCI triggering the CQI/RI report and/or a PDSCH or the configured CSI-RS resource(s) for CQI/RI measurement. The network entity 104 transmits 1008 PDSCH or the configured CSI-RS resources to the UE 102. The UE 102 provides feedback 1020 on the downlink transmissions to the network entity 104. The UE 102 transmits 1010 CSI report that includes a wideband portion of the CQI or a subband portion of the CQI, based on (1) the RI associated with a number of selected DMRS ports and indicating multiple DMRS ports, and/or (2) a CQI offset.

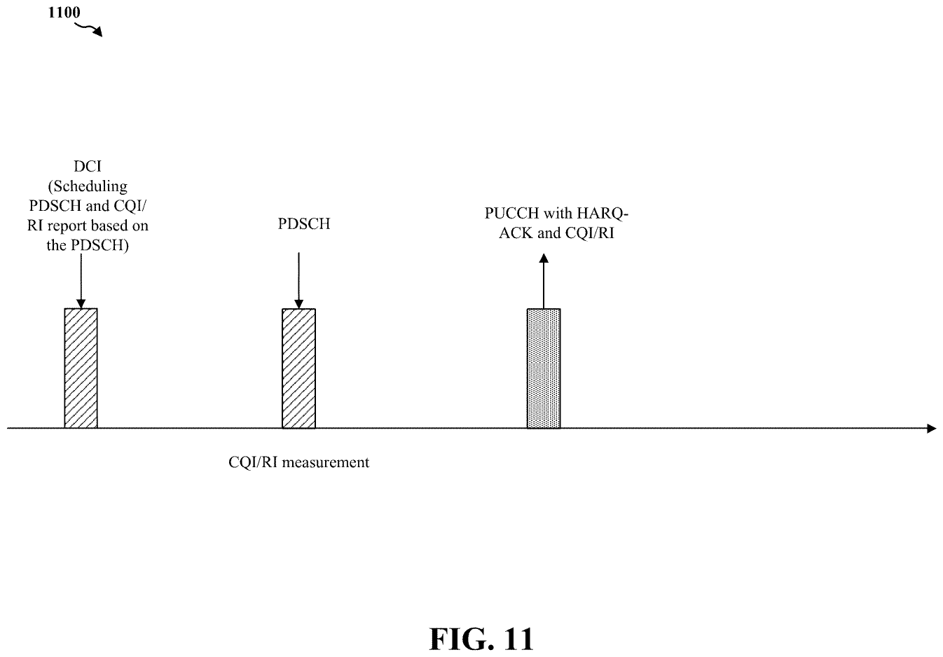

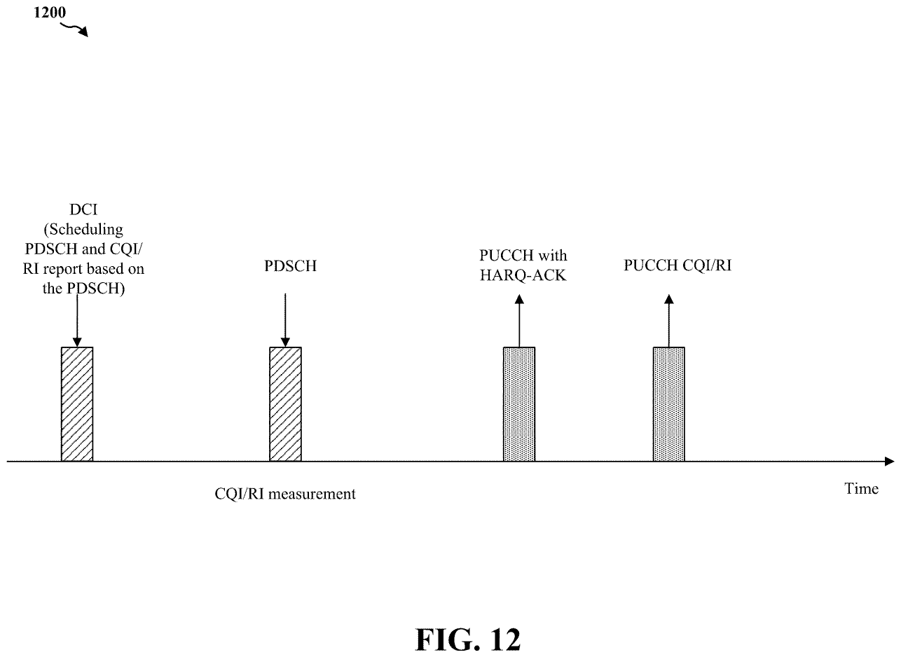

FIG. 11 illustrates an example 1100 of a CQI/RI report and PDSCH triggered by one DCI and the CQI/RI and HARQ-ACK information reported by one PUCCH resource, according to aspects of the present disclosure. As shown, when the network entity configures the UE to report CQI or CQI and RI related information based on the DMRS for a PDSCH, the network entity may trigger the CQI/RI report by the same DCI as that used to trigger the PDSCH. The network entity may configure or indicate the CQI/RI report by the same PUCCH as that used for the HARQ-ACK information report. An alternative option is illustrated in FIG. 12.

FIG. 12 illustrates an example 1200 of a CQI/RI report and PDSCH triggered by one DCI and the CQI/RI and HARQ-ACK information reported by separate PUCCH resources, according to aspects of the present disclosure. Compared to the example 1100, in the example 1200, the PUCCH transmission with HARQ-ACK is separate from the PUCCH transmission with the CQI/RI. As shown, the network entity may configure or indicate a separate PUCCH resources for the CQI/RI report by RRC signaling, MAC CE or the same DCI used to trigger the CQI/RI report.

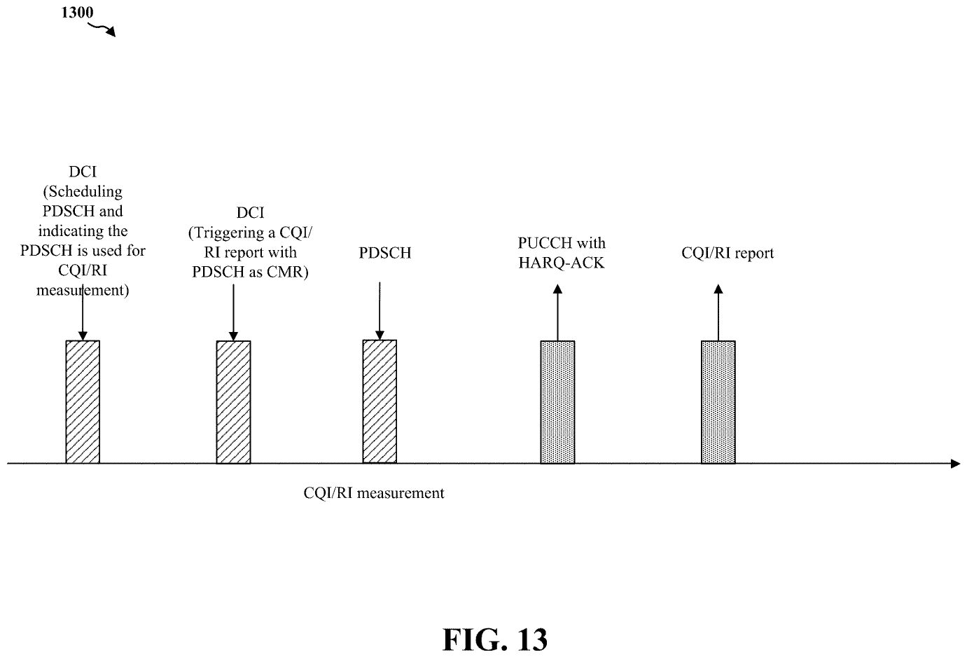

FIG. 13 illustrates an example 1300 of a CQI/RI report and PDSCH triggered by separate DCIs, according to aspects of the present disclosure. As shown, the network entity may trigger the CQI/RI report by a separate DCI. The network entity may configure the CMR for the report as PDSCH. The network may indicate whether a PDSCH is used for CQI/RI measurement or not by the scheduling DCI. The network entity may configure the PUSCH resource for the CQI/RI report based on the PDSCH by the DCI. FIG. 13 illustrates one example for the CQI/RI report and PDSCH triggered by separate DCIs.

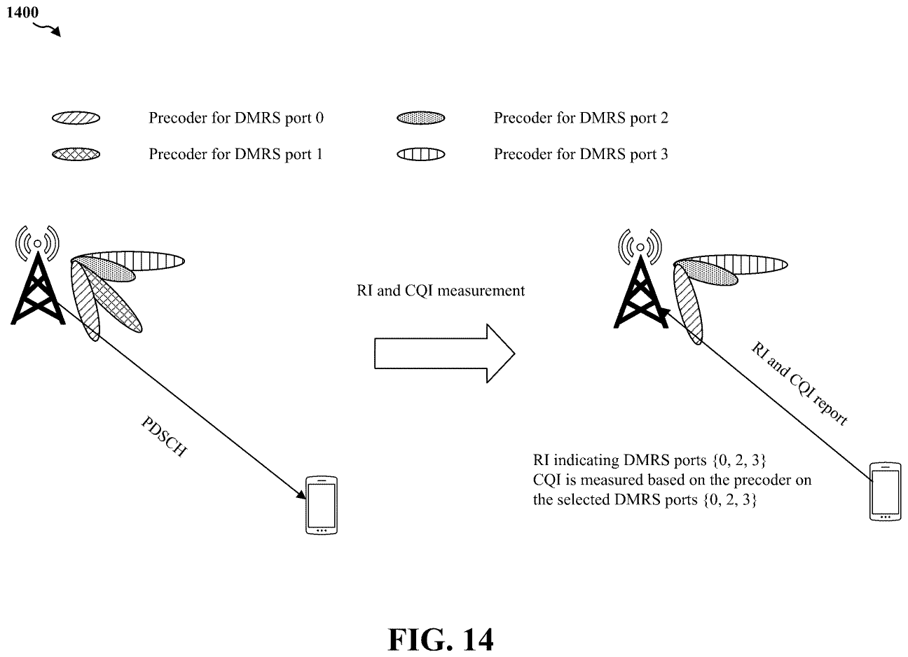

FIG. 14 illustrates an example 1400 of a CQI/RI report based on selected DMRS ports, according to aspects of the present disclosure. As shown, when the network entity configures the UE to report CQI or CQI and RI based on the DMRS for a PDSCH, the network entity may transmit the PDSCH (e.g., operation illustrated on the left of the example 1400) based on the received ML compressed CSI. The network entity may configure the UE to report the ML compressed CSI based on precoder(s) with a certain rank for a CSI report (e.g., four example precoders and respective beams are illustrated in the example 1400). In some cases, the network entity may configure the UE to report the precoder(s) corresponding to the maximum rank, where the maximum rank is the minimum of the number of CSI-RS ports and the maximum number of downlink layers the UE reported in the UE capability.

As shown on the right of the example 1400 in FIG. 14, the UE reports the CQI and RI to the network entity (e.g., RI indicating DMRS ports). In some cases, the UE may report wideband CQI only. Alternatively, the network entity may configure the frequency domain report granularity for the CQI report. Thus, the network entity may configure the UE to report subband CQIs. The network entity may configure the subband size by RRC signaling. Alternatively, the network entity and UE may determine the subband size based on the physical resource block (PRB) bundling size or resource block group (RBG) size for the PDSCH transmission and reception.

In some implementations, the UE reports RI and CQI to the network entity. The UE reports the CQI based on the reported RI. The UE may report the RI indicating the selected DMRS ports. In one example, the UE may report a M bits bitmap, where the first value of bit x may indicate the DMRS port x is selected and the second value of bit x may indicate the DMRS port x is not selected. The value of M is the number of the scheduled DMRS ports. Alternatively, the UE may report the RI indicating the number of selected DMRS ports. Then the UE reports RI=K indicating the first K+1 DMRS ports are selected. The UE reports the CQI based on the selected DMRS ports.

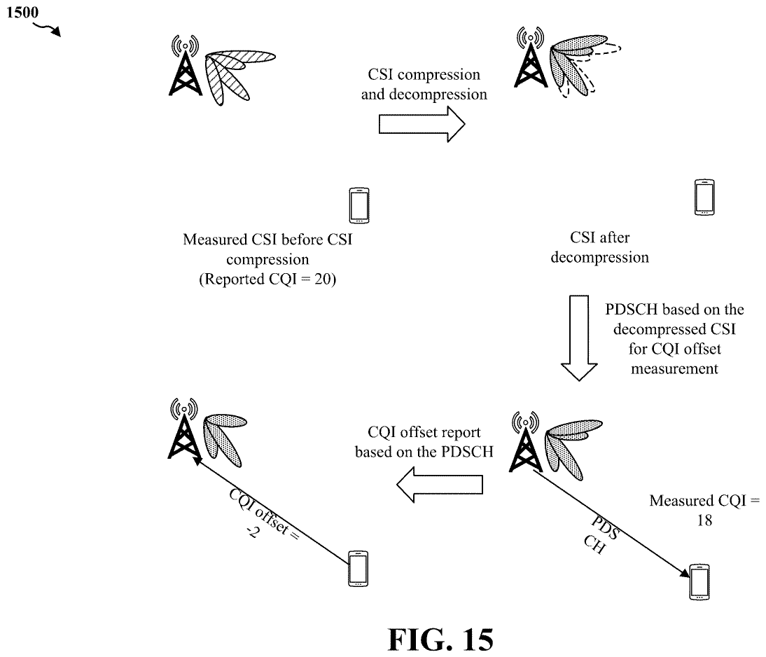

FIG. 15 illustrates an example 1500 of a CQI offset report based on DMRS for PDSCH, according to aspects of the present disclosure. As shown, the network entity configures the UE to report CQI offset based on the DMRS for a PDSCH and the most recent CQI reported corresponding to a ML compressed CSI. During operation, the network entity configures the UE to report the ML compressed CSI including RI, CQI and ML compressed PMIs. The UE measures the CQI based on the PMIs before the compression.

The network entity applies the decompressed precoders to the PDSCH (bottom right of the example 1500). In the DCI used to trigger the CQI offset report, the network entity may indicate the CSI report configuration ID or ML model ID. Then the UE measures the CQI based on the DMRS for the PDSCH, and compare the measured CQI and the most recent reported CQI corresponding to the same CSI report configuration ID or ML model ID, and report the CQI offset.

In some implementations, the UE reports (bottom left of the example 1500) the CQI offset based on the reported wideband CQI and measured wideband CQI. In some other implementations, the UE reports the CQI offset for each subbands based on the reported subband CQIs and the measured subband CQIs.

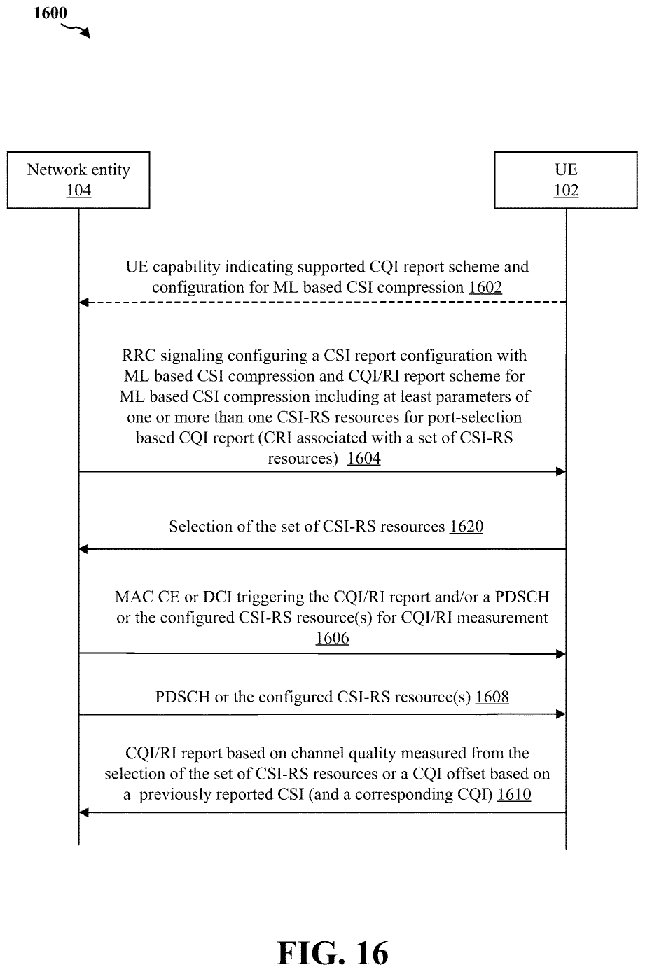

FIG. 16 is a signaling diagram 1600 illustrating communications between a UE and a network entity for reducing errors using one or more CSI reference signal (CSI-RS) resources for port-selection based CQI report, according to aspects of the present disclosure. As shown, similar to the operations in FIGS. 3, 4, and 5, the UE 102 optionally transmits 1602 the UE capability indicating supported CQI report scheme and the configuration for ML based CSI compression to the network entity 104. The network entity 104 transmits 1604 to the UE 102 RRC signaling that configures a CSI report configuration with ML based CSI compression and CQI/RI report scheme for ML based CSI compression. The signaling includes parameters of one or more CSI-RS resources for port-selection based CQI report (e.g., CRI associated with a set of CSI-RS resources). The UE 102 informs 1620 the network entity 104 of a selection of the set of CSI-RS resources.

The network entity 104 then transmits 1606 a MAC CE or DCI triggering the CQI/RI report and/or a PDSCH or the configured CSI-RS resource(s) for CQI/RI measurement. The network entity 104 transmits 1608 PDSCH or the configured CSI-RS resources to the UE 102. The UE 102 transmits 1610 CSI report based on channel quality measured from the selection of the set of CSI-RS resources or a CQI offset based on a previously reported CSI (and a corresponding CQI).

When the network entity configures the UE to report CQI or CQI and CRI based on a set of CSI-RS resources by RRC signaling, MAC CE or DCI, the network entity may configure the UE to report the ML compressed CSI based on precoder(s) with a certain rank for a CSI report. In an example, the network entity may configure the UE to report the precoder(s) corresponding to the maximum rank, where the maximum rank is the minimum of the number of CSI-RS ports and the maximum number of downlink layers the UE reported in the UE capability. Then the network entity applies each layer of the received precoders for each CSI-RS resource. The network entity may configure the set of CSI-RS resources by RRC signaling, MAC CE, or DCI. The network entity may dynamically deactivate or activate one or more than one CSI-RS resources in the CSI-RS resource set by MAC CE or DCI.

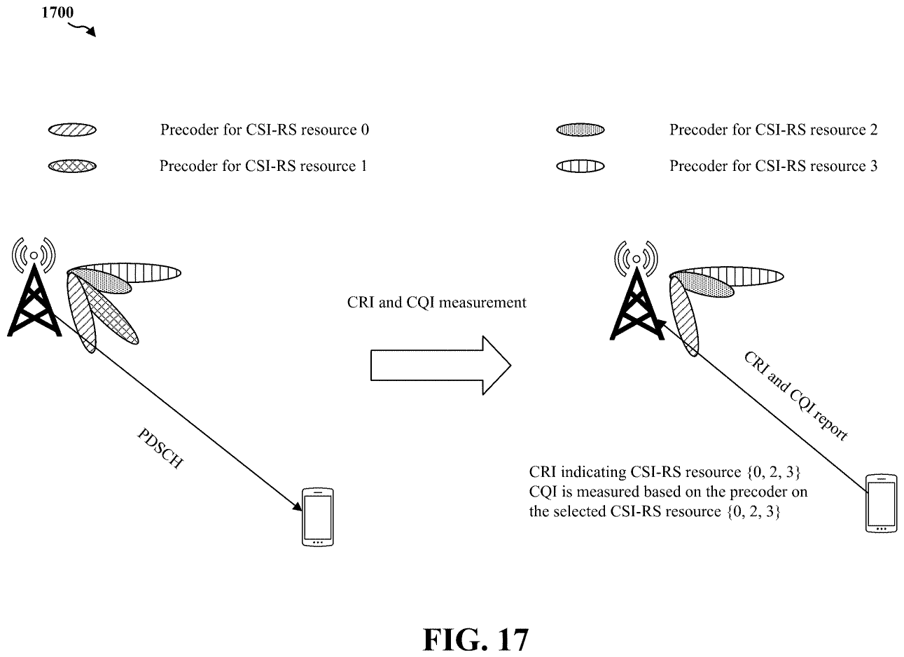

FIG. 17 illustrates an example 1700 of a CSI-RS resource indicator (CRI) and CQI report based on a set of CSI-RS resources, according to aspects of the present disclosure. As shown, after CRI and CQI measurement, the UE reports a CRI indicating one or more selected CSI-RS resources (e.g., {0, 2, 3} as shown in the example 1700). The CQI is measured based on the precoder on the selected CSI-RS resources. In some cases, the UE reports an M bits bit-map. In the bit-map, the first state of bit x may indicate the CSI-RS resource that has not been selected and the second state of bit x may indicate the CSI-RS resource that has been selected. Then the UE reports the CQI based on the selected CSI-RS resources.

In some implementations, the UE may report the CQI indicating the channel quality measured from the selected CSI-RS resources. In some other implementations, the UE may report the CQI offset based on the most recent reported ML compressed CSI and the measured CQI.

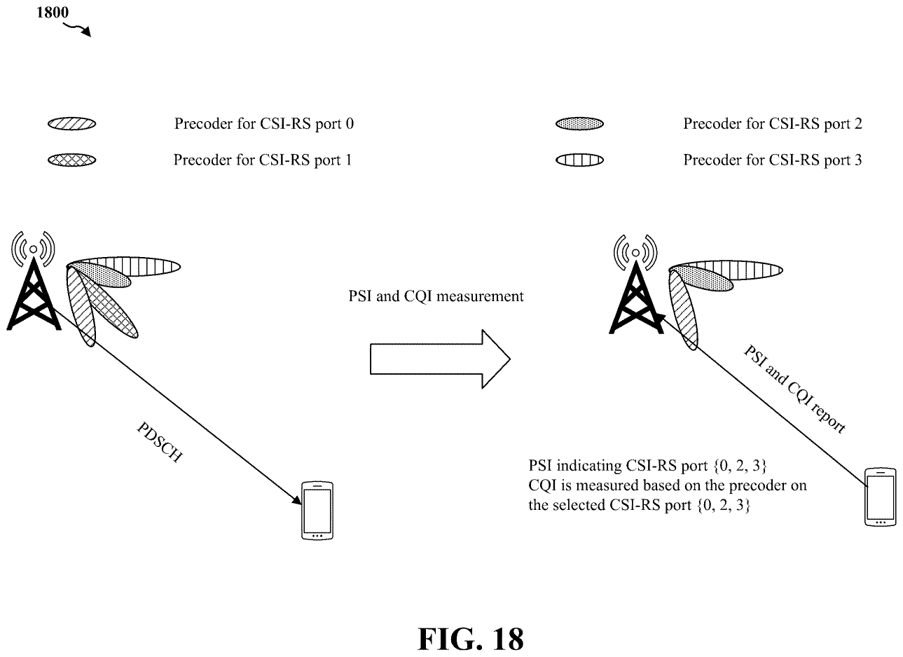

FIG. 18 illustrates an example 1800 of a port selection indicator (PSI) and CQI report based on a CSI-RS resource, according to aspects of the present disclosure. As shown, the network entity may configure the UE to report CQI or CQI and a port selection indicator (PSI) based on a CSI-RS resource by RRC signaling, MAC CE or DCI. On the right of the example 1800, the UE reports a PSI indicating the selected CSI-RS resource(s). For example, the UE reports an M bits bit-map, in which the first state of bit x may indicate the CSI-RS port x that has not been selected and the second state of bit x may indicate the CSI-RS port x that has been selected. Then the UE reports the CQI based on the selected CSI-RS ports.

When the network entity configures the UE to report the ML compressed CSI based on precoder(s) with a certain rank for a CSI report, the network entity may configure the UE to report the precoder(s) corresponding to the maximum rank. For example, the maximum rank is the minimum of the number of CSI-RS ports and the maximum number of downlink layers the UE reported in the UE capability. Then the network entity applies the received precoders for CSI-RS resource for the CQI/PSI report. The network entity may configure the CSI-RS resource by RRC signaling, MAC CE, or DCI. The network entity may dynamically update the number of ports for the CSI-RS resource by MAC CE or DCI.

In some implementations, the UE may report the CQI indicating the channel quality measured from the selected CSI-RS ports. In some other implementations, the UE may report the CQI offset based on the most recent reported ML compressed CSI and the measured CQI.

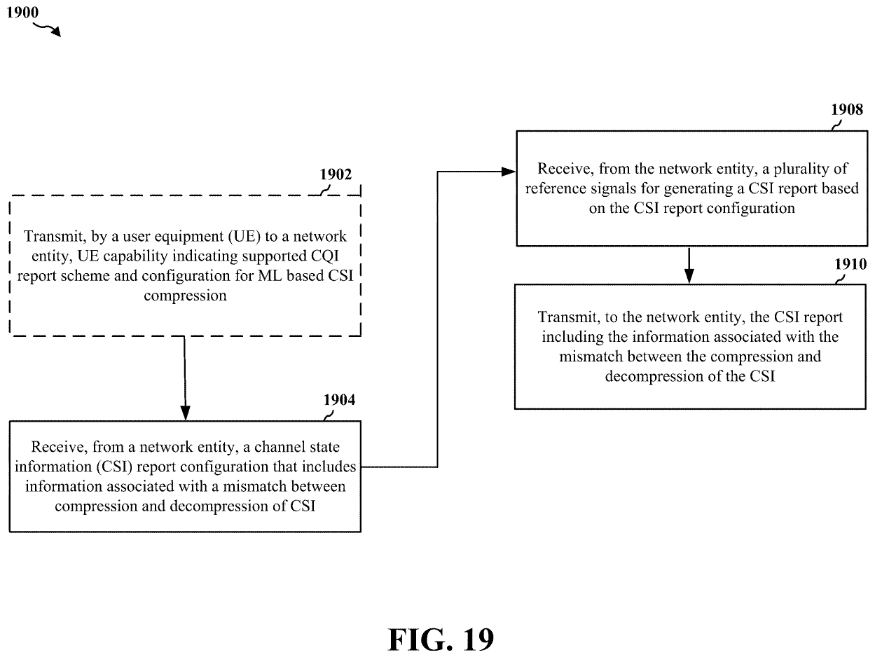

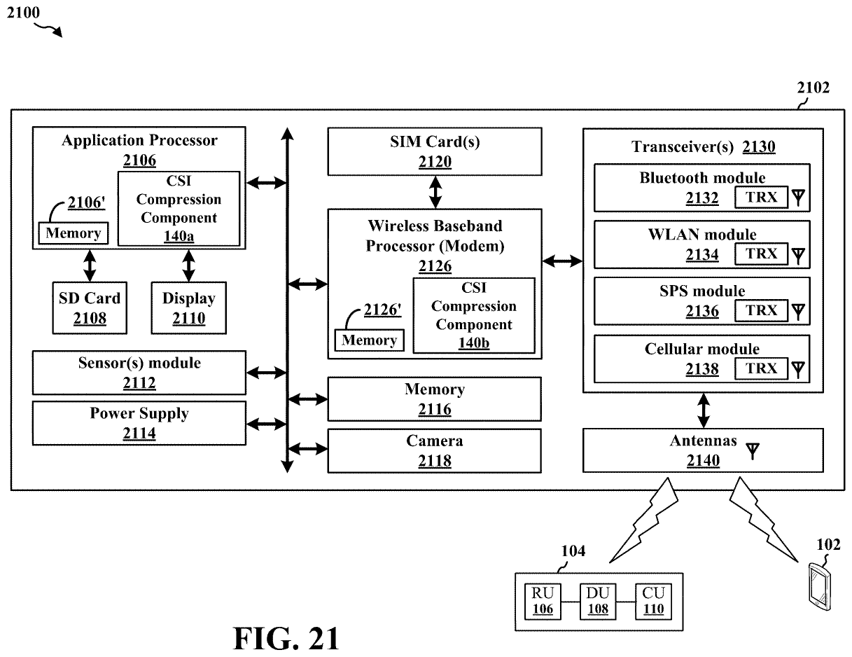

FIG. 19 illustrates a flowchart 1900 of a method of wireless communication at a UE. With reference to FIGS. 1 and 21, the method may be performed by the UE 102, the UE apparatus 2102, etc., which may include the memory 2126′, 2106′, 2116, and which may correspond to the entire UE 102 or the entire UE apparatus 2102, or a component of the UE 102 or the UE apparatus 2102, such as the wireless baseband processor 2126 and/or the application processor 2106.

The UE transmits 1902 to a network entity, a capability indicating supported CQI report scheme and configuration for ML based CSI compression (e.g., operation 302 of FIG. 3, operation 402 of FIG. 4). The UE receives 1904, from the network entity, a CSI report configuration that includes information associated with a mismatch between compression and decompression of CSI (e.g., operation 304 of FIG. 3, operation 404 of FIG. 4).

The UE receives 1908, from the network entity, a plurality of reference signals for generating a CSI report based on the CSI report configuration (e.g., operation 308 of FIG. 3, operation 408 of FIG. 4). The UE transmits 1910, to the network entity, the CSI report including the information associated with the mismatch between the compression and decompression of the CSI (e.g., operation 310 of FIG. 3, operation 410 of FIG. 4).

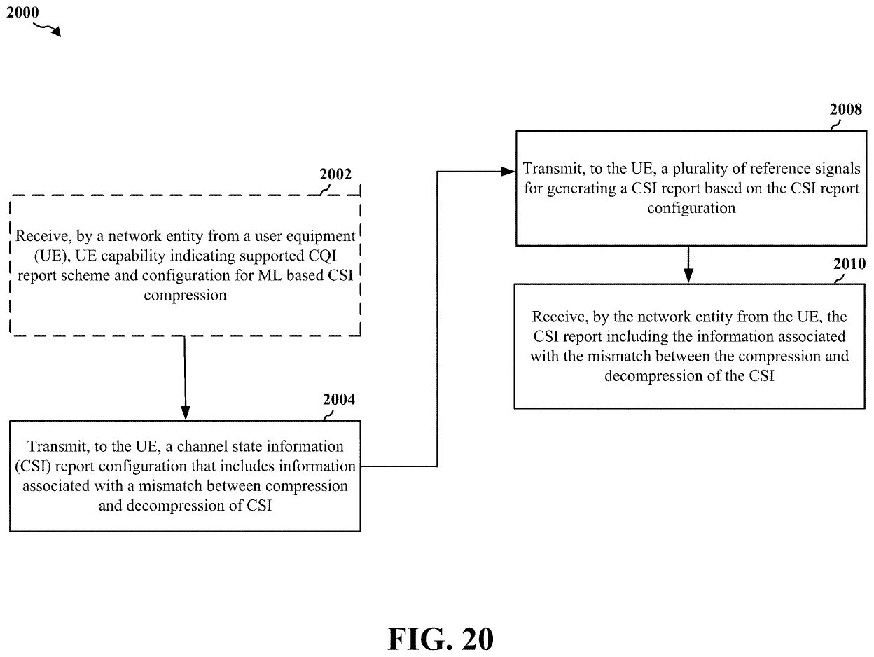

FIG. 19 describes a method from a UE-side of a wireless communication link, whereas FIG. 20 describes a method from a network-side of the wireless communication link.

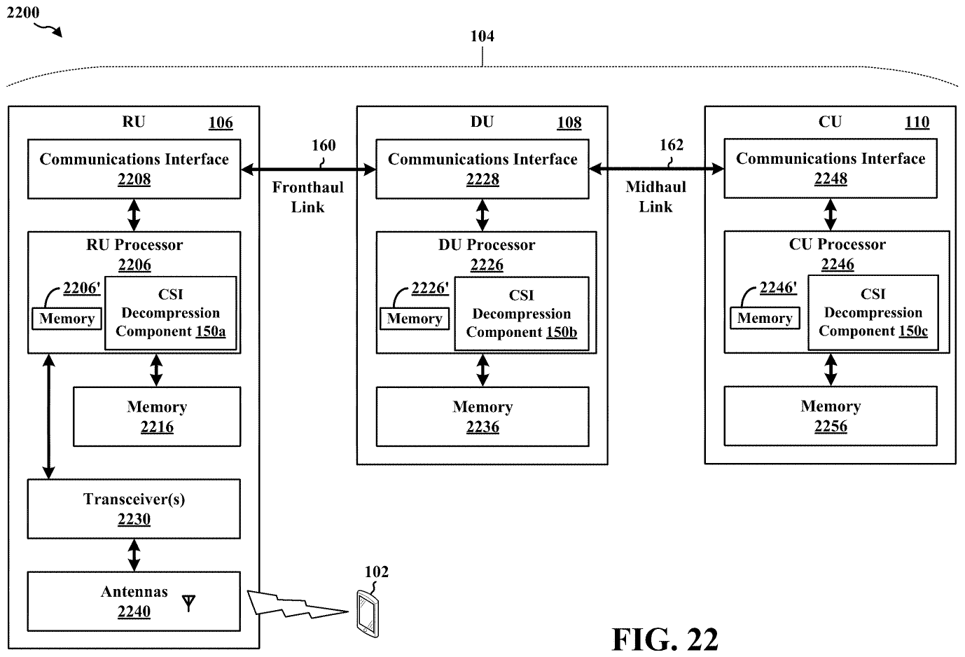

FIG. 20 is a flowchart 2000 of a method of wireless communication at a network entity. With reference to FIGS. 1 and 22, the method may be performed by one or more network entities 104, which may correspond to a base station or a unit of the base station, such as the RU 106, the DU 108, the CU 110, an RU processor 2206, a DU processor 2226, a CU processor 2246, etc. The one or more network entities 104 may include memory 2206′/2226′/2246′, which may correspond to an entirety of the one or more network entities 104, or a component of the one or more network entities 104, such as the RU processor 2206, the DU processor 2226, or the CU processor 2246.

The network entity receives 2002, from a user equipment (UE), a UE's capability indicating supported CQI report scheme and configuration for ML based CSI compression (e.g., operation 302 of FIG. 3, operation 502 of FIG. 5). The network entity transmits 2004, to the UE, a CSI report configuration that includes information associated with a mismatch between compression and decompression of CSI (e.g., operation 304 of FIG. 3, operation 504 of FIG. 5).

The network entity transmits 2008, to the UE, a plurality of reference signals for generating a CSI report based on the CSI report configuration (e.g., operation 306 of FIG. 3, operation 508 of FIG. 5). The network entity receives 2010, from the UE, the CSI report including the information associated with the mismatch between the compression and decompression of the CSI (e.g., operation 308 of FIG. 3, operation 510 of FIG. 5).

Regarding both FIGS. 19 and 20, one or more detail aspects may be implemented. For example, the UE may compress a precoder matrix (and/or other content of the CSI report, not limited to the precoder matrix) based on a first transform-based model for the CSI report. The compressed precoder matrix is to be decompressed based on a second transform-based model. In some cases, the UE may implement a first machine-learning algorithm to obtain one or more parameters for the compression of the precoder matrix in the CSI. Similarly, the network entity may implement a second machine-learning algorithm to obtain one or more parameters for decompressing the CSI to obtain the compressed precoder matrix.

In aspects, the CSI report configuration may include a compensation factor for calculating a channel quality indicator (CQI) and a rank indicator (RI). The compensation factor is determined by the network entity based on feedback from the UE regarding one or more downlink transmissions. The information may be associated with the compensation factor or the feedback. In some cases, the feedback from the UE includes: at least one consecutive negative-acknowledgement of the one or more downlink transmissions, and correspondingly, the compensation factor comprises a negative value; or at least one consecutive acknowledgement of the one or more downlink transmissions, and correspondingly, the compensation factor comprises a positive value.

In some cases, the compensation factor is reset in view of a resetting event, the resetting event comprises at least one of: a handover procedure; an activation or deactivation of a serving cell; switching to another bandwidth part (BWP); switching to a third transform-based model; receiving signaling for updating configuration of the plurality of reference signals configured as channel measurement resource (CMR); or receiving signaling for updating the CSI report configuration.

In some cases, the UE receives, from the network entity, a radio resource control (RRC) message configuring the compensation factor specific to: the first transform-based model, or the CSI report.

In aspects, the UE receives from the network entity, a MAC CE including: a serving cell index to which the compensation factor is applied; a bandwidth part index to which the compensation factor is applied; a CSI report configuration identifier (ID) to which the compensation factor is applied; a machine learning (ML) model ID of the first transform based model in which the compensation factor is applied; or a CQI compensating factor for CQI calculation, the CQI compensating factor indicating the compensation factor for calculating the CQI or a power offset between CSI reference signal (CSI-RS) and physical downlink shared channel (PDSCH).

In aspects, the UE applies the compensation factor to calculate the CQI based on: a time period after a last symbol of an acknowledgement for a downlink transmission associated with the MAC CE; or a time period after a last symbol of a received downlink transmission associated with the MAC CE. In some cases, the UE receives, from the network entity, a downlink control information (DCI) triggering the CSI report, the DCI including the compensation factor for calculating the CQI.

In aspects, the UE determines the compensation factor based on a status of the feedback. The compensation factor is determined based on at least one of: a step size for increasing or decreasing the compensation factor; a condition for increasing or decreasing the compensation factor, the condition related to a number of consecutive acknowledgements (ACKs) or negative-acknowledgements (NACKs); or a range of the compensation factor. In some cases, the UE maintains the compensation factor for the first transform-based model. The UE may update the compensation factor when a different transform-based model or a compression parameter thereof is used.

In aspects, the indication from the network entity includes a downlink control information (DCI) triggering a physical downlink shared channel (PDSCH) as well as the CSI report. In some cases, the UE receives downlink transmissions on the PDSCH triggered by the DCI, and transmits, to the network entity in a feedback of the downlink transmissions, the CSI report including the CQI and RI, wherein the feedback includes a hybrid automatic repeat request-acknowledgment (HARQ-ACK) transmitted via a physical uplink control channel (PUCCH). In some cases, the information comprises a rank of a precoder associated with the downlink transmission, a number of CSI reference signal (CSI-RS) ports, or a number of downlink layers. In some cases, the UE transmits a wideband portion of the CQI or a subband portion of the CQI. A size of the subband portion is configured by the network entity.

In aspects, the UE reports the CQI based on the RI. The RI is associated with a number of selected DMRS ports and indicates a plurality of demodulation reference signal (DMRS) ports.

In aspects, the information includes a CQI offset based on a CQI calculated using one or more received demodulation reference signals (DMRS) for a physical downlink shared channel (PDSCH) and a previous reported CQI. In some cases, the UE receives, from the network entity, an indication of a CSI report configuration identifier or a model identifier of the first transform-based model associated with the previously reported CQI.

In aspects, the CSI report configuration configures the UE to report the CQI, or the CQI and one or more CSI reference signals (CSI-RSs) resource indicator (CRI), based on a set of CSI-RS resources; and wherein the information comprises respective precoders associated with CSI-RS ports of the set of CSI-RS resources. In some cases, the UE reports the CRI indicating a selection of the set of CSI-RS resources.

In aspects, the CSI report configuration configures the UE to report the CQI, or the CQI and a port selection indicator (PSI), based on a set of CSI-RS resources; and wherein the information comprises respective precoders associated with CSI-RS ports of the set of CSI-RS resources. In some cases, the UE reports the CQI indicating channel quality measured from the selection of the set of CSI-RS resources or a CQI offset based on a previously reported CSI and a corresponding previously reported CQI.

A UE apparatus 2102, as described in FIG. 21 below, may perform the method of flowchart 1900. The one or more network entities 104, as described in FIG. 22 below, may perform the method of flowchart 2000.

FIG. 21 is a diagram 2100 illustrating an example of a hardware implementation for a UE apparatus 2102. The UE apparatus 2102 may be the UE 102, a component of the UE 102, or may implement UE functionality. The UE apparatus 2102 may include an application processor 2106, which may have on-chip memory 2106′. In examples, the application processor 2106 may be coupled to a secure digital (SD) card 2108 and/or a display 2110. The application processor 2106 may also be coupled to a sensor(s) module 2112, a power supply 2114, an additional module of memory 2116, a camera 2118, and/or other related components. For example, the sensor(s) module 2112 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 2102 may further include a wireless baseband processor 2126, which may be referred to as a modem. The wireless baseband processor 2126 may have on-chip memory 2126′. Along with, and similar to, the application processor 2106, the wireless baseband processor 2126 may also be coupled to the sensor(s) module 2112, the power supply 2114, the additional module of memory 2116, the camera 2118, and/or other related components. The wireless baseband processor 2126 may be additionally coupled to one or more subscriber identity module (SIM) card(s) 2120 and/or one or more transceivers 2130 (e.g., wireless RF transceivers).

Within the one or more transceivers 2130, the UE apparatus 2102 may include a Bluetooth module 2132, a WLAN module 2134, an SPS module 2136 (e.g., GNSS module), and/or a cellular module 2138. The Bluetooth module 2132, the WLAN module 2134, the SPS module 2136, and the cellular module 2138 may each include an on-chip transceiver (TRX), or in some cases, just a transmitter (TX) or just a receiver (RX). The Bluetooth module 2132, the WLAN module 2134, the SPS module 2136, and the cellular module 2138 may each include dedicated antennas and/or utilize antennas 2140 for communication with one or more other nodes. For example, the UE apparatus 2102 may communicate through the transceiver(s) 2130 via the antennas 2140 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 2126 and the application processor 2106 may each include a computer-readable medium/memory 2126′, 2106′, respectively. The additional module of memory 2116 may also be considered a computer-readable medium/memory. Each computer-readable medium/memory 2126′, 2106′, 2116 may be non-transitory. The wireless baseband processor 2126 and the application processor 2106 may each be responsible for general processing, including execution of software stored on the computer-readable medium/memory 2126′, 2106′, 2116. The software, when executed by the wireless baseband processor 2126/application processor 2106, causes the wireless baseband processor 2126/application processor 2106 to perform the various functions described herein. The computer-readable medium/memory may also be used for storing data that is manipulated by the wireless baseband processor 2126/application processor 2106 when executing the software. The wireless baseband processor 2126/application processor 2106 may be a component of the UE 102. The UE apparatus 2102 may be a processor chip (e.g., modem and/or application) and include just the wireless baseband processor 2126 and/or the application processor 2106. In other examples, the UE apparatus 2102 may be the entire UE 102 and include the additional modules of the apparatus 2102.

As discussed in FIG. 1 and implemented with respect to FIGS. 6 and 19, the CSI compression component 140 is configured to receiving, from a network entity, a CSI report configuration that includes information associated with a mismatch between compression and decompression of CSI. The CSI compression component 140 receives, from the network entity, multiple reference signals for generating a CSI report based on the CSI report configuration. The CSI compression component 140 transmits, to the network entity, the CSI report including the information associated with the mismatch between the compression and decompression of the CSI.

The CSI compression component 140 may be within the application processor 2106 (e.g., at 190a), the wireless baseband processor 2126 (e.g., at 190b), or both the application processor 2106 and the wireless baseband processor 2126. The CSI compression component 190a-190b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 22 is a diagram 2200 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 2246, which may have on-chip memory 2246′. In some aspects, the CU 110 may further include an additional module of memory 2256 and/or a communications interface 2248, both of which may be coupled to the CU processor 2246. The CU 110 may communicate with the DU 108 through a midhaul link 162, such as an F1 interface between the communications interface 2248 of the CU 110 and a communications interface 2228 of the DU 108.

The DU 108 may include a DU processor 2226, which may have on-chip memory 2226′. In some aspects, the DU 108 may further include an additional module of memory 2236 and/or the communications interface 2228, both of which may be coupled to the DU processor 2226. The DU 108 may communicate with the RU 106 through a fronthaul link 160 between the communications interface 2228 of the DU 108 and a communications interface 2208 of the RU 106.

The RU 106 may include an RU processor 2206, which may have on-chip memory 2206′. In some aspects, the RU 106 may further include an additional module of memory 2216, the communications interface 2208, and one or more transceivers 2230, all of which may be coupled to the RU processor 2206. The RU 106 may further include antennas 2240, which may be coupled to the one or more transceivers 2230, such that the RU 106 may communicate through the one or more transceivers 2230 via the antennas 2240 with the UE 102.

The on-chip memory 2206′, 2226′, 2246′ and the additional modules of memory 2216, 2236, 2256 may each be considered a computer-readable medium/memory. Each computer-readable medium/memory may be non-transitory. Each of the processors 2206, 2226, 2246 is responsible for general processing, including execution of software stored on the computer-readable medium/memory. The software, when executed by the corresponding processor(s) 2206, 2226, 2246 causes the processor(s) 2206, 2226, 2246 to perform the various functions described herein. The computer-readable medium/memory may also be used for storing data that is manipulated by the processor(s) 2206, 2226, 2246 when executing the software. In examples, the CSI decompression component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIGS. 7 and 20, the CSI decompression component 150 is configured to transmitting, to the UE, a CSI report configuration that includes information associated with a mismatch between compression and decompression of CSI. The CSI decompression component 150 transmits, to the UE, a plurality of reference signals for generating a CSI report based on the CSI report configuration. The CSI decompression component 150 receives, by the network entity, the CSI report including the information associated with the mismatch between the compression and decompression of the precoder matrix in the CSI. The CSI decompression component 150 may be within one or more processors of the one or more network entities 104, such as the RU processor 2206 (e.g., at 200a), the DU processor 2226 (e.g., at 200b), and/or the CU processor 2246 (e.g., at 200c). The CSI decompression component 200a-200c may be one or more hardware components specifically configured to carry out the stated processes/algorithm, implemented by one or more processors 2206, 2226, 2246 configured to perform the stated processes/algorithm, stored within a computer-readable medium for implementation by the one or more processors 2206, 2226, 2246, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and may include a random-access memory (RAM), a read-only memory (ROM), an electrically erasable programmable ROM (EEPROM), optical disk storage, magnetic disk storage, other magnetic storage devices, combinations of these types of computer-readable media, or any other medium that may be used to store computer executable code in the form of instructions or data structures that may be accessed by a computer. Storage media may be any available media that may be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “may”, as used in this disclosure, often carry certain connotations. For example, “may” refers to a permissible feature that may or may not occur, “might” refers to a feature that probably occurs, and “may” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” may universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1. A method for wireless communications by a user equipment (UE), the method comprising:
receiving, from a network entity, a channel state information (CSI) report configuration that includes information associated with a mismatch between compression and decompression of CSI;
receiving, from the network entity, a plurality of reference signals for generating a CSI report based on the CSI report configuration; and
transmitting, to the network entity, the CSI report including the information associated with the mismatch between the compression and decompression of the CSI.

Example 2. The method of Example 1, further comprising:
compressing a precoder matrix based on a first transform-based model for the CSI report, wherein the precoder matrix therein are to be decompressed based on a second transform-based model.

Example 3. The method of Example 2, wherein compressing the precoder matrix in the CSI based on the first transform-based model comprises:
implementing a machine-learning algorithm to obtain one or more parameters for the compression of the precoder matrix in the CSI.

Example 4. The method of Example 2, wherein the CSI report configuration comprises:
a compensation factor for calculating a channel quality indicator (CQI) and a rank indicator (RI), wherein the compensation factor is determined by the network entity based on feedback from the UE regarding one or more downlink transmissions, and wherein the information is associated with the compensation factor or the feedback.

Example 5. The method of Example 4, wherein the feedback from the UE comprises:
at least one consecutive negative-acknowledgement of the one or more downlink transmissions, and correspondingly, the compensation factor comprises a negative value; or
at least one consecutive acknowledgement of the one or more downlink transmissions, and correspondingly, the compensation factor comprises a positive value.

Example 6. The method of Example 4, wherein the compensation factor is reset in view of a resetting event, the resetting event comprises at least one of:
a handover procedure;
an activation or deactivation of a serving cell;
switching to another bandwidth part (BWP);
switching to a third transform-based model;
receiving signaling for updating configuration of the plurality of reference signals configured as channel measurement resource (CMR); or
receiving signaling for updating the CSI report configuration.

Example 7. The method of any one of Examples 4 to 6, further comprising:
receiving, from the network entity, a radio resource control (RRC) message configuring the compensation factor specific to:
the first transform-based model, or
the CSI report.

Example 8. The method of any one of Examples 4 to 6, further comprising:
receiving, from the network entity, a media access control (MAC) control element (CE) comprising at least one of:
   a serving cell index to which the compensation factor is applied;
   a bandwidth part index to which the compensation factor is applied;
   a CSI report configuration identifier (ID) to which the compensation factor is applied;
   a machine learning (ML) model ID of the first transform based model in which the compensation factor is applied; or
   a CQI compensating factor for CQI calculation, the CQI compensating factor indicating the compensation factor for calculating the CQI or a power offset between CSI reference signal (CSI-RS) and physical downlink shared channel (PDSCH).

Example 9. The method of Example 8, further comprising:
applying the compensation factor to calculate the CQI based on:
   a time period after a last symbol of an acknowledgement for a downlink transmission associated with the MAC CE; or
   a time period after a last symbol of a received downlink transmission associated with the MAC CE.

Example 10. The method of any one of Examples 4 to 9, further comprising:
receiving, from the network entity, a downlink control information (DCI) triggering the CSI report, the DCI including the compensation factor for calculating the CQI.

Example 11. The method of any one of Examples 4 to 9, further comprising:
determining, by the UE, the compensation factor based on a status of the feedback, wherein the compensation factor is determined based on at least one of:
   a step size for increasing or decreasing the compensation factor;
   a condition for increasing or decreasing the compensation factor, the condition related to a number of consecutive acknowledgements (ACKs) or negative-acknowledgements (NACKs); or
   a range of the compensation factor.

Example 12. The method of Example 11, further comprising:
maintaining the compensation factor for the first transform-based model; and
updating the compensation factor when a different transform-based model or a compression parameter thereof is used.

Example 13. The method of Example 2, wherein the indication from the network entity comprises a downlink control information (DCI) triggering a physical downlink shared channel (PDSCH) as well as the CSI report.

Example 14. The method of Example 13, further comprising:
receiving downlink transmissions on the PDSCH triggered by the DCI; and
transmitting, to the network entity in a feedback of the downlink transmissions, the CSI report including the CQI and RI, wherein the feedback includes a hybrid automatic repeat request-acknowledgment (HARQ-ACK) transmitted via a physical uplink control channel (PUCCH).

Example 15. The method of Example 13 or 14, wherein the information comprises a rank of a precoder associated with the downlink transmission, a number of CSI reference signal (CSI-RS) ports, or a number of downlink layers.

Example 16. The method of any one of Examples 13 to 15, wherein transmitting the CSI report comprises:
transmitting a wideband portion of the CQI or a subband portion of the CQI, wherein a size of the subband portion is configured by the network entity.

Example 17. The method of any one of Examples 13 to 16, wherein transmitting the CSI report comprises:
reporting the CQI based on the RI, wherein the RI is associated with a number of selected DMRS ports and indicates a plurality of demodulation reference signal (DMRS) ports.

Example 18. The method of Example 13, wherein the information comprises a CQI offset based on a CQI calculated using one or more received demodulation reference signals (DMRS) for a physical downlink shared channel (PDSCH) and a previous reported CQI.

Example 19. The method of Example 18, further comprising:
receiving, from the network entity, an indication of a CSI report configuration identifier or a model identifier of the first transform-based model associated with the previously reported CQI.

Example 20. The method of Example 1, wherein the CSI report configuration configures the UE to report the CQI, or the CQI and one or more CSI reference signal (CSI-RS) resource indicators (CRIs), based on a set of CSI-RS resources; and wherein the information comprises respective precoders associated with CSI-RS ports of the set of CSI-RS resources.

Example 21. The method of Example 20, further comprising:
reporting, by the UE to the network entity, the CRI indicating a selection of the set of CSI-RS resources.

Example 22. The method of Example 1, wherein the CSI report configuration configures the UE to report the CQI, or the CQI and a port selection indicator (PSI), based on a set of CSI-RS resources; and wherein the information comprises respective precoders associated with CSI-RS ports of the set of CSI-RS resources.

Example 23. The method of any one of Examples 20 to 22, further comprising:
reporting, by the UE to the network entity, the CQI indicating channel quality measured from the selection of the set of CSI-RS resources or a CQI offset based on a previously reported CSI and a corresponding previously reported CQI.

Example 24. A method for wireless communications by a network entity, the method comprising:
transmitting (304), to a user equipment (UE), a channel state information (CSI) report configuration that includes information associated with a mismatch between compression and decompression of CSI;
transmitting (310/1610), to the UE, a plurality of reference signals for generating a CSI report based on the CSI report configuration; and
receiving (312), by the network entity, the CSI report including the information associated with the mismatch between the compression and decompression of the CSI.

Example 25. The method of Example 24, further comprising:
decompressing a precoder matrix in the CSI report based on a second transform-based model, wherein the precoder matrix has been compressed by the UE based on a first transform-based model.

Example 26. The method of Example 25, wherein decompressing the precoder matrix in the CSI report based on the second transform-based model comprises:
implementing a machine-learning algorithm to obtain one or more parameters for the decompression of the precoder matrix in the CSI.

Example 27. An apparatus for wireless communication comprising a transceiver, a memory, and a processor coupled to the memory and the transceiver, the apparatus being configured to implement a method as in any of Examples 1 to 29.

Example 28. An apparatus, comprising a processer configured to cause a User Equipment (UE) to:
receive radio resource configuration (RRC) signaling configuring one of the following parameters:
Channel Quality Indicator (CQI) compensation factor; or
Enabling or disabling the UE-determined CQI compensation factor; or
CQI report with demodulation reference signal (DMRS) of physical downlink shared channel (PDSCH) based channel measurement resource (CMR); or
CQI and a port selection indicator (PSI) report with one or more than one channel state information reference signal (CSI-RS) resource.
transmit one of the following:
CQI based on a CQI compensation factor; or
CQI offset based on a reference CQI; or
CQI and a PSI.

Example 29. An apparatus, comprising a processer configured to cause a Base Station (BS) to:
transmit radio resource configuration (RRC) signaling configuring one of the following parameters:
Channel Quality Indicator (CQI) compensation factor; or
Enabling or disabling the UE-determined CQI compensation factor; or
CQI report with demodulation reference signal (DMRS) of physical downlink shared channel (PDSCH) based channel measurement resource (CMR); or
CQI and a port selection indicator (PSI) report with one or more than one channel state information reference signal (CSI-RS) resource.
receive one of the following:
CQI based on a CQI compensation factor; or
CQI offset based on a reference CQI; or
CQI and a PSI.

1-20. (canceled)

21. A method for wireless communications by a user equipment (UE), the method comprising:
receiving, from a network entity, a channel state information (CSI) report configuration that includes information associated with a mismatch between compression and decompression of CSI;
receiving, from the network entity, a plurality of reference signals for generating a CSI report based on the CSI report configuration; and
transmitting, to the network entity, the CSI report including the information associated with the mismatch between the compression and decompression of the CSI.

22. The method of claim 21, further comprising:
compressing a precoder matrix based on a first transform-based model for the CSI report, wherein the compressed precoder matrix is to be decompressed based on a second transform-based model.

23. The method of claim 22, wherein compressing the precoder matrix in the CSI based on the first transform-based model comprises:
implementing a machine-learning algorithm to obtain one or more parameters for the compression of the precoder matrix in the CSI, wherein the CSI report configuration comprises:
a compensation factor for calculating a channel quality indicator (CQI) and a rank indicator (RI), wherein the compensation factor is determined based on feedback from the UE regarding one or more downlink transmissions, and wherein the information is associated with the compensation factor or the feedback.

24. The method of claim 23, wherein the feedback from the UE comprises:
at least one consecutive negative-acknowledgement of the one or more downlink transmissions, and correspondingly, the compensation factor comprises a negative value; or
at least one consecutive acknowledgement of the one or more downlink transmissions, and correspondingly, the compensation factor comprises a positive value.

25. The method of claim 23, wherein the compensation factor is reset in view of a resetting event, the resetting event comprises at least one of:
a handover procedure;
an activation or deactivation of a serving cell;
switching to another bandwidth part (BWP);
switching to a third transform-based model;
receiving signaling for updating configuration of the plurality of reference signals configured as channel measurement resource (CMR); or
receiving signaling for updating the CSI report configuration.

26. The method of claim 23, further comprising:
receiving, from the network entity, a media access control (MAC) control element (CE) comprising at least one of:
a serving cell index to which the compensation factor is applied;
a bandwidth part index to which the compensation factor is applied;
a CSI report configuration identifier (ID) to which the compensation factor is applied;
a machine learning (ML) model ID of the first transform based model in which the compensation factor is applied; or
a CQI compensating factor for CQI calculation, the CQI compensating factor indicating the compensation factor for calculating the CQI or a power offset between CSI reference signal (CSI-RS) and physical downlink shared channel (PDSCH).

27. The method of claim 23, further comprising:
receiving, from the network entity, a downlink control information (DCI) triggering the CSI report, the DCI including the compensation factor for calculating the CQI.

28. The method of claim 23, further comprising:
determining, by the UE, the compensation factor based on a status of the feedback, wherein the compensation factor is determined based on at least one of:
a step size for adjusting the compensation factor;
a condition for adjusting the compensation factor, the condition related to a number of consecutive acknowledgements (ACKs) or negative-acknowledgements (NACKs); or
a range of the compensation factor;
maintaining the compensation factor for the first transform-based model; and
updating the compensation factor when a different transform-based model or a compression parameter thereof is used.

29. The method of claim 21, wherein the information comprises a rank of a precoder associated with downlink transmission, a number of CSI reference signal (CSI-RS) ports, or a number of downlink layers.

30. The method of claim 23, wherein transmitting the CSI report comprises:
transmitting a wideband portion of the CQI or a subband portion of the CQI, wherein a size of the subband portion is configured by the network entity.

31. The method of claim 23, wherein transmitting the CSI report comprises:
reporting the CQI based on the RI, wherein the RI is associated with a number of selected plurality of demodulation reference signal (DMRS) ports and indicates a plurality of DMRS ports, wherein the information comprises a CQI offset based on a CQI calculated using one or more received DMRSs for a physical downlink shared channel (PDSCH) and a previous reported CQI.

32. The method of claim 23, wherein the CSI report configuration configures the UE to report the CQI, or the CQI and one or more CSI reference signals (CSI-RSs) resource indicator (CRI), based on a set of CSI-RS resources; and wherein the information comprises respective precoders associated with CSI-RS ports of the set of CSI-RS resources.

33. The method of claim 23, wherein the CSI report configuration configures the UE to report the CQI, or the CQI and a port selection indicator (PSI), based on a set of CSI-RS resources; and wherein the information comprises respective precoders associated with CSI-RS ports of the set of CSI-RS resources.

34. A method for wireless communications by a network entity, the method comprising:
transmitting, to a user equipment (UE), a channel state information (CSI) report configuration that includes information associated with a mismatch between compression and decompression of CSI;
transmitting, to the UE, a plurality of reference signals for generating a CSI report based on the CSI report configuration; and
receiving, from the UE, the CSI report including the information associated with the mismatch between the compression and decompression of the CSI.

35. An apparatus for wireless communication at a user equipment (UE), the apparatus comprising:
a transceiver;
a memory; and
a processor coupled to the memory and the transceiver, the processor configured to:
receive, from a network entity, a channel state information (CSI) report configuration that includes information associated with a mismatch between compression and decompression of CSI;
receive, from the network entity, a plurality of reference signals for generating a CSI report based on the CSI report configuration; and
transmit, to the network entity, the CSI report including the information associated with the mismatch between the compression and decompression of the CSI.

36. The apparatus of claim 35, wherein the processor is further configured to:
compress a precoder matrix based on a first transform-based model for the CSI report, wherein the compressed precoder matrix is to be decompressed based on a second transform-based model.

37. The apparatus of claim 36, wherein the processor configured to compress the precoder matrix is further configured to:
implement a machine-learning algorithm to obtain one or more parameters for the compression of the precoder matrix in the CSI, wherein the CSI report configuration comprises:
a compensation factor for calculating a channel quality indicator (CQI) and a rank indicator (RI), wherein the compensation factor is determined based on feedback from the UE regarding one or more downlink transmissions, and wherein the information is associated with the compensation factor or the feedback.

38. The apparatus of claim 37, wherein the feedback from the UE comprises:
at least one consecutive negative-acknowledgement of the one or more downlink transmissions, and correspondingly, the compensation factor comprises a negative value; or
at least one consecutive acknowledgement of the one or more downlink transmissions, and correspondingly, the compensation factor comprises a positive value.

39. The apparatus of claim 37, wherein the compensation factor is reset in view of a resetting event, the resetting event comprises at least one of:
a handover procedure;
an activation or deactivation of a serving cell;
switching to another bandwidth part (BWP);
switching to a third transform-based model;
receiving signaling for updating configuration of the plurality of reference signals configured as channel measurement resource (CMR); or
receiving signaling for updating the CSI report configuration.

40. The apparatus of claim 37, wherein the processor is further configured to:
receive, from the network entity, a media access control (MAC) control element (CE) comprising at least one of:
a serving cell index to which the compensation factor is applied;
a bandwidth part index to which the compensation factor is applied;
a CSI report configuration identifier (ID) to which the compensation factor is applied;
a machine learning (ML) model ID of the first transform based model in which the compensation factor is applied; or
a CQI compensating factor for CQI calculation, the CQI compensating factor indicating the compensation factor for calculating the CQI or a power offset between CSI reference signal (CSI-RS) and physical downlink shared channel (PDSCH).
